(19) United States
(12) Patent Application Publication
(10) Pub. No.: US 2016/0162582 A1
(43) Pub. Date: Jun. 9, 2016

(54) METHOD AND SYSTEM FOR CONDUCTING AN OPINION SEARCH ENGINE AND A DISPLAY THEREOF

(71) Applicant: MOODWIRE, INC., Menlo Park, CA (US)

(72) Inventors: Manjirnath CHATTERJEE, San Francisco, CA (US); Erick WATSON, Sammamish, WA (US)

(21) Appl. No.: 14/738,042

(22) Filed: Jun. 12, 2015

Related U.S. Application Data
(60) Provisional application No. 62/089,244, filed on Dec. 9, 2014.

(51) Int. Cl. G06F 17/30

(52) U.S. Cl. CPC G06F 17/30867; G06F 17/30528; G06F 17/3053; G06F 17/30554; G06F 17/30345

(57) ABSTRACT

Embodiments of the present invention provide a system, Embodiments of the present invention are directed to methods, computer program products, computer systems for providing a computing search platform for conducting opinion searches over the Internet concerning aggregated social media electronic messages about public opinions and public sentiments for wide variety of matrices, such as social media posting of a particular industry over a specified time period, electronic social media posting on the public sentiments, public buzz, public mood on US senators, or electronic social media textual data of the upcoming US presidential election of Republic and Democrat candidates. An opinion search engine serves as the backbone in complex data crunching of thousands or millions of electronic social media messages which detect, extract, compute, and correlate both unstructured textual data and structured textual data. In response to a search query submitted through an opinion search bar, the opinion search engine processes the query to return an aggregated result in a transformed visual representation of the selected one or more entities, as well as public buzz, public mood, and other public sentiments on one or more related products, to the user's computer display.

### CROSS REFERENCE TO RELATED PATENT APPLICATION

This application claims priority to U.S. Provisional Application Ser. No. 62/089,244 entitled “Consumer Opinion Search and Display using Machine Algorithms,” filed on 9 Dec. 2014, the disclosure of which is incorporated herein by reference in its entirety.

### TECHNICAL FIELD

The present invention relates generally to computer searching technologies, and more particularly, providing an opinion search platform that processes voluminous amount of unstructured and structured social media textual data for display the aggregated public opinions in a visual transformed structural representation on a computer display.

### BACKGROUND OF INFORMATION

Software-based search engines have become a popular and nearly indispensable tool as a query method for quickly finding facts and data about the myriad of topics that can be retrieved on both public and private computer networks globally. These search engines serve as a central location to locate objective data in documents, such as web pages or published papers, as well as various public and private data sources. These commercially available search engines typically also return related salient pieces of information about the topic under consideration, as well as a generic description of the topic itself. For example, a computer search for the celebrity “Justin Bieber” on either search engine http://www.google.com or http://www.bing.com, two of the most popular and widely used commercial search engines, will return not only facts and data about Mr. Bieber, but also recent news articles about him, photographs of him, playlists containing his published recordings, lists of movies that he starred in, and other information relating to him in this example, as illustrated in FIG. 1A which shows the search results for the celebrity “Justin Bieber”, returned from http://www.google.com on Mar. 26, 2015 and FIG. 1B which shows the search results for the celebrity “Justin Bieber”, returned from http://www.bing.com on Mar. 26, 2015.

Conventional search engines have been surprising slow in adopting to and incorporating the rapid advances in social media posts that have become fabric of today's society and as a reflecting of the general public sentiments on hot topics. Although search engines return useful facts and data about the topic under consideration, they suffer the following drawbacks and do return any of the following: human opinion about the topic under consideration; how much popular ‘buzz’ exists—the total number of results returned, segregated by positive, negative, and neutral sentiment expressed about the topic under consideration; positivity, as expressed by favorable human sentiment, towards the topic under consideration; negativity, as expressed by unfavorable human sentiment, towards the topic under consideration; how public opinion, both positive and negative, about the topic under consideration has changed over time; and user feedback, including the ability for users to “vote up” or “vote down” a given search result.

In parallel with developments in search engine technology, there has been numerous conventional sentiment analysis pertaining to natural language processing methods and software that can identify positive or negative human sentiment in a given sample of text. Various well-known methods exist for deriving such information, such as traditional polling, online survey tools, automated phone calls to survey recipients, etc., as well as numerous commercial and open source software packages that can be applied to measure and score the human sentiment contained in written text, speech, and other embodiments of natural language.

Prior sentiment analysis techniques possess several disadvantages which include generally missing several useful features. These techniques do not apply to the presentation of online advertisements: current online advertisements do not incorporate human sentiment as a measure of ad relevance or context. These techniques also do not apply to application programming interface (API) output or monetization: while API's are not new, human opinion has not been used as the primary function which governs the manner that API results are provided.

Accordingly, it is desirable to have a system and method that provide an opinion search platform that source, analyze, compute and analyze a large amount of unstructured and structured social media electronic messages from various sources featuring natural language processing with sentiment analysis and entity groupings to produce one or more visual representations to reflect the opinion search result.

### SUMMARY OF THE INVENTION

Embodiments of the present invention are directed to methods, computer program products, computer systems for providing a computing search platform for conducting opinion searches over the Internet concerning aggregated social media electronic messages about public opinions and public sentiments for a wide variety of matrices, such as social media posting of a particular industry over a specified time period, electronic social media posting on the public sentiments, public buzz, public mood on US senators, or electronic social media textual data of the upcoming US presidential election of Republic and Democrat candidates. An opinion search engine serves as the backbone in complex data crunching of thousands or millions of electronic social media messages which an opinion search engine detects, extracts, computes, and correlates both unstructured textual data and structured textual data. In response to a search query submitted through an opinion search bar, the opinion search engine processes the query to return an aggregated result in a transformed visual representation of the selected one or more entities, as well as public buzz, public mood, and other public sentiments on one or more related products, to the user's computer display.

The opinion search engine includes a storm check module, an entity extract module, vertical-specific module, a sentiment extract module, an exact match module, an entity ranking module, and an opinion visual representation mapping module. In one embodiment, the opinion search is based on the user generated contents posted on various social media sites, such as Facebook, Twitter, Yelp, and others. The horizontal opinion search system includes software pipeline process, production data storage aggregate, and entity builder database aggregate. In one embodiment of a horizontal opinion search engine/software pipeline process, the invention includes an entity extract module, a sentiment extract module, an entity ranking module, and a horizontal opinion visual representation module.

The sentiment extract module is further comprised of generic module, trained sentiment module, and math probabilistic classifier module. The sentiment extract module is configured to differentiate and isolate the sentiment from the textual data. In other embodiments of the invention, sentiment extract module can contain any number of other modules that will combine to generate a score for textual data from social media websites. The score help determines the sentiment of a piece of textual data. Horizontal opinion search result can be displayed as a visual mapping representation structure on the user's computer display.

Broadly stated, a computer-implemented method for conducting an opinion search, comprises extracting entity information and attributes from each structured electronic social media message in the plurality of structured electronic social media messages and extracting entity information and attributes from each normalized unstructured electronic social media message in the plurality of unstructured electronic social media messages; scoring a composite sentiment value and attributes for the text in each structured electronic social media message or each normalized unstructured electronic social media message, storing the scored structured electronic social media messages and the scored normalized unstructured electronic social media message in a database; and aggregating the results of the scored structured electronic social media messages and the scored normalized unstructured electronic social media messages for one or more entities organized for display as a transformed visual representation.

The structure and methods of the present invention are disclosed in the detail description below. This summary does not purport to define the invention. The present invention has many different embodiments and may be applied to numerous different environments. Variations upon and modifications to these embodiments are provided for by the present invention, which is limited only by the claims. These and other embodiments, features, aspects, and advantages of the invention will become better understood with regard to the following description, appended claims and accompanying drawings.

The structures and methods of the present invention are disclosed in the detailed description below. This summary does not purport to define the invention. The invention is defined by the claims. These and other embodiments, features, aspects, and advantages of the invention will become better understood with regard to the following description, appended list of claims, and accompanying drawings.

### BRIEF DESCRIPTION OF THE DRAWINGS

The disclosure will be described with respect to specific embodiment thereof, and reference will be made to the drawing, in which:

FIGS. 1A-B are conventional graphical illustrations that depicts the common search result from software-based search engine for the query term “Justin Bieber” using the Google search engine the Bing search engine, respectively.

FIG. 2 is a system diagram illustrating one embodiment of an opinion search system 10 which is coupled to a communication network for sourcing social media electronic messages in accordance with the present disclosure.

FIG. 3 is a software system diagram illustrating one embodiment of the opinion search engine including a storm check module, a duplicate-rejecter module, a spam check module, an entity extract module, a vertical-specific module, a sentiment extract module, an exact match module, a job classifier module, an entity ranking module, an opinion visual representation module, and a bus coupling the various modules, in accordance with the present disclosure.

FIG. 4 is a block diagram illustrating the process flow of data processing of structured and unstructured social media electronic messages through the opinion search engine and query processing through the API, in accordance with the present disclosure.

FIG. 5 is a flow diagram illustrating the structured entity data storage which receives multiple entity information and attributes from various sources in accordance with the present disclosure.

FIG. 6A is a flow diagram illustrating the process flow of the opinion search engine for horizontal opinion processing to generating a structural visual mapping representation in accordance with the present disclosure; and FIG. 6B is a flow diagram illustrating the process flow of the opinion search engine for horizontal opinion processing to generating a structural visual mapping representation in accordance with the present disclosure.

FIG. 7 is a graphical diagram illustrating sample webpages that are available for viewing by Moodwire Inc. in accordance with the present disclosure.

FIG. 8 is a graphical diagram that provides one illustration in the main partition processes of the opinion search engine in accordance with the present disclosure.

FIG. 9 is a flow diagram that illustrates the process flow of the opinion search system in normalizing and scoring unstructured social media electronic messages in accordance with the present disclosure.

FIG. 10 is a graphical diagram that provides an illustration of the opinion search system in collecting, scanning, and analyzing with raw quotes and machine scored results and generating trends and reports with graphical representations in accordance with the present disclosure.

FIG. 11 is a graphical diagram illustrating sampling of synthesized public opinions in correlated MoodRank Graph and BuzzRank Graph for a particular hotel brand in accordance with the present disclosure.

FIG. 12 is a flow diagram illustrating the process flow of the query API pipeline procedure in accordance with the present disclosure.

FIG. 13 is a graphical diagram illustrating an example of the opinion search interface screen on a webpage as hosted by Moodwire Inc. in accordance with the present disclosure.

FIG. 14 is a graphical diagram illustrating one embodiment of an aggregated result generated by the opinion search engine with a topic image, sentiment and buzz, related links, news stories and quotes, syndicated content and comments in accordance with the present disclosure.

FIG. 15 is a graphical diagram illustrating an example of the opinion search result displayed with the sentiment summary, public buzz and public mood over a time period in accordance with the present disclosure.

FIG. 16 is a graphical diagram illustrating an embodiment of the opinion search result displayed with both the sentiment summary and the computed advertisements related to the search query in accordance with the present disclosure.

FIG. 17 is a graphical diagram illustrating an embodiment of the opinion search engine result with the sentiment summary and a related advertisement in accordance with the present disclosure.

FIG. 18 is a graphical diagram illustrating one embodiment of the opinion search result which provide sentiment summaries, public buzzes and public moods for two entities in accordance with the present disclosure.

FIGS. 19A-O are graphical diagrams illustrating the different examples of opinion search results from the opinion search engine with the visual transformed structural representation in accordance with the present disclosure. FIG. 19A is an embodiment of the search result for air transportation; FIG. 19B is an embodiment of the search result for motor vehicles; FIG. 19C is an embodiment of the search result for regional bank; FIG. 19D is an embodiment of the search result for US state capitals; FIG. 19E is an embodiment of the search result for S&P 500 Index; FIG. 19F is an embodiment of the search result for NBA teams; FIG. 19G is an embodiment of the search result for NFL teams; FIG. 19H is an embodiment of the search result for NHL teams; FIG. 19I is an embodiment of the search result for MLB teams; FIG. 19J is an embodiment of the search result for actors; FIG. 19K is an embodiment of the search result for celebrities; FIG. 19L is an embodiment of the search result for singers; FIG. 19M is an embodiment of the search result for US senate; FIG. 19N is an embodiment of the search result for professional bull riders; and FIG. 19O is an embodiment of the search result for hotels and motels.

FIG. 20 is a graphical diagram illustrating an embodiment of the word cloud generated from an opinion search result which shows another visual transformed structural representation by company products in accordance with the present disclosure.

FIG. 21 is a block diagram illustrating an exemplary computer system for processing the push notifications upon which a computing embodiment of the present disclosure may be implemented in accordance with the present disclosure.

### DETAILED DESCRIPTION

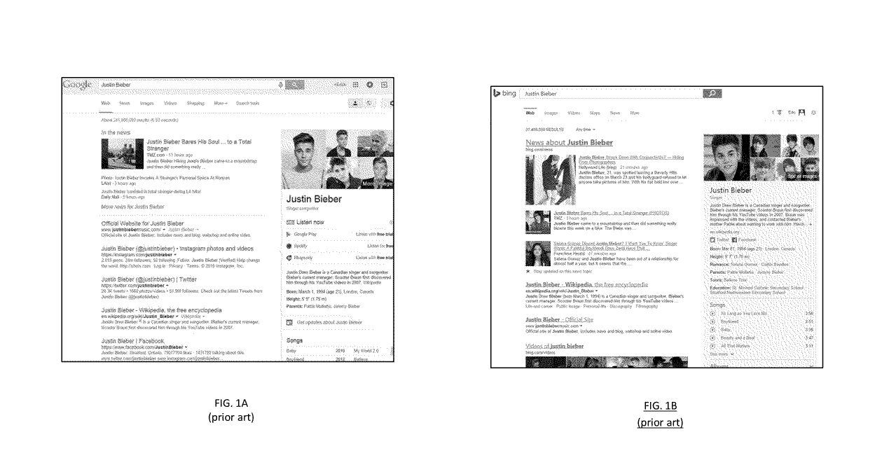

A description of structural embodiments and methods of the present invention is provided with reference to FIGS. 1-21. It is to be understood that there is no intention to limit the invention to the specifically disclosed embodiments but that the invention may be practiced using other features, elements, methods, and embodiments. Like elements in various embodiments are commonly referred to with like reference numerals. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The following definitions apply to the elements and steps described herein. These terms may likewise be expanded upon.

Application Programming Interface (API)—refers to a programmatic interface for reading sentiment data from the Moodwire cloud service.

Buzz—refers to the number of tallied mentions about a given topic, during a discrete time interval. (Example Usage—During the past month in February 2015, Justin Bieber had a buzz of 1,543,654 mentions on the World Wide Web.)

Entity—refers to an Entity is a meta-concept of noun/person/etc. The fragment of text is just a representation (or clue) of that entity being used in a certain context but that piece of text is not the entity, just a reference to it. This is semantically relevant because “I flew on United” contains the word “United” but the reference to Entity: United_Airlines is only true because of the verb “flew” && (object==word(“United”)) so “United” is simply a word that, in another context, could refer to “United States” or something entirely different.

Entry (syn. Post, Mention)—refers to a single fragment of text, which may come from a review, a tweet etc.

Horizontal Entities—refers to a horizontal collection of entities with a broad range of offerings to a large group of customers with a wide range of needs, such as businesses as a whole, men, women, households, or in the broadest sense of a horizontal market, everyone.

Human Opinion—refers to a view or judgment formed by people, (as opposed to machines), about a given topic, not necessarily based on fact or knowledge. Opinions are generally expressed on a varying scale of positive to negative, with a neutral indicating the absence of opinion.

Micro-blog—refers to a social media site to which a user makes short, frequent electronic social media posts.

Natural Language Processing—refers to a field of computer science, artificial intelligence, and linguistics concerned with the interactions between computers and human languages.

Ontological relationship—In one embodiment, this term refers to naming and defining the types, properties, and interrelationships of the entities that exist for a particular domain of discourse. An ontology compartmentalizes the variables for some set of computations and establishes the relationships between them (e.g. taxonomy).

Overall Polarity—refers to a combined score of all the Piece Scores. Many different types of item scores are possible depending on how the Piece Scores are weighted.

Quote Sentiment—refers to a subpart of an item that can be an atomic unit of measurable sentiment. Score entries are by made by humans or computers.

Semi-structured Data—refers to a form of structured data that does not conform with the formal structure of data models associated with relational databases or other forms of data tables, but nonetheless contains tags or other markers to separate semantic elements and enforce hierarchies of records and fields within the data.

Sentiment—refers to a view of or attitude toward a situation or event; an opinion.

Sentiment Score—refers to sentiment scoring where each Item is scored based on the sum of the Piece scores. Pieces, which are not scored or scored as “Mixed” or “Unknown”, are treated as 0.

Spam—refers to unsolicited electronic messages, especially advertising, as well as messages sent repeatedly on the same site.

Stream—refers to a string of items (e.g. a days' worth of reviews at Yelp, or 10,000 Twitter tweets).

Tagvana—refers to Moodwire's crowd sourced human scoring and quality assurance (QA) tool. Tagvana is used for sentiment engine tooling and accuracy assessments.

Storm—refers to bursts of social media communications that recursively grow according to a power law.

Structured Data—refers to data that resides in a fixed field or record, such as data commonly found in a relational database.

Unstructured Data—refers to information that either does not have a pre-defined data model or is not organized in a pre-defined manner.

Vertical collection entities—refers a collection of entities related to a specific to an industry, trade, profession, or other group of customers with specialized needs. It is distinguished from a horizontal collection of entities, which implies a broad range of offerings to a large group of customers with a wide range of needs, such as businesses as a whole, men, women, households, or, in the broadest horizontal market, everyone.

Web Crawler—refers to a web crawler is an Internet bot that systematically browses the World Wide Web, typically for the purpose of Web indexing. A Web crawler may also be called a Web spider, an ant, an automatic indexer, or a Web scutter.

Window (or Epoch)—refers to a set period of time during which a Stream is examined. This can be a minute or an hour, or a week etc. For example when we publish a graph of a given score vs. time we can choose different time scales such as 1-minute resolution, 1-hour resolution, 2.5 day resolution, 1-week resolution etc.

Windowing Effect—As the time scale (Epoch) gets longer fast changing events in a Stream are more difficult to see because they get smooth out by the length of the time window examined. This effect of smoothing vs. window length is called the “windowing” effect in signal processing and informatics theory. Many different valid approaches for dealing with windowing are possible depending on the type of information preservation desired.

FIG. 1A-B are graphical illustrations that depicts the common search result from software-based search engine for the query term “Justin Bieber”. Software-based search engines are routinely used to find objective data in documents, such as web pages or published papers, as well as many other public and private data sources. The result page using software-based search engine often related salient pieces of information about the topic under consideration, as well as a generic description of the topic itself. A search query for “Junstin Bieber” will return not only facts and data about Mr. Bieber, but also recent news articles about him, photographs of him, playlists containing his published recordings, lists of movies that he starred in, and other information relating to him in this example. FIG. 1A is the search result from using the Google search engine; FIG. 1B is the search result from using the Bing search engine.

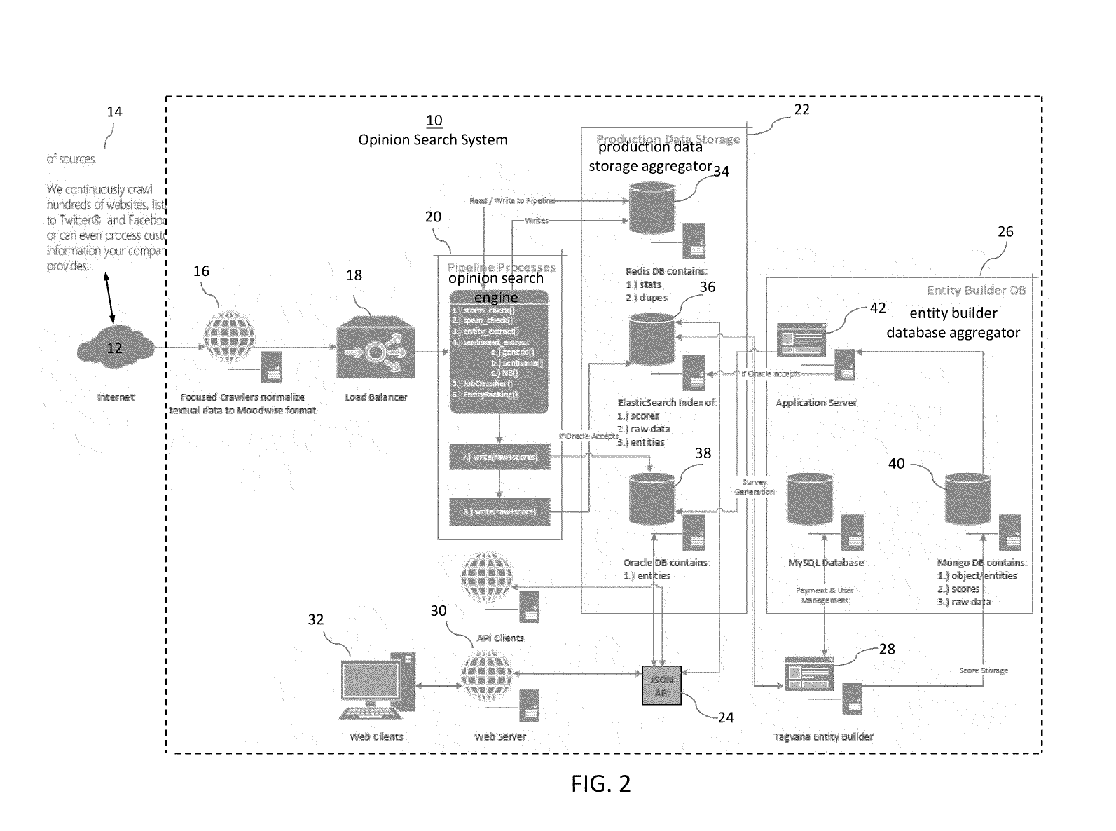

FIG. 2 is a system diagram illustrating one embodiment of an opinion search system 10 which is coupled to a communication network 12 (e.g., the Internet, a wireless network, etc.) for sourcing social media electronic messages (also referred to as “textual data,” “tweets,” or “text messages”) 14. The opinion search system comprises focused crawlers 14, a load balancer 18, an opinion search engine (also referred to as “pipeline processes”) 20, a production data storage aggregator 22 coupled to an application program interface (API) 24, and an entity builder database aggregator 26 coupled to an entity builder 28. The entity builder 28 is also coupled to the production data storage aggregator 22. The application program interface 24 is further coupled to API clients 30, which is further coupled to web clients 32. The focused crawlers 14 are software modules on a computer that are designed to collect text directly from various websites built using hypertext markup language (HTML) and related technologies. The focused crawlers 14 are configured to collect textual data from the Internet 12 and normalize the social media electronic messages into a particular format suitable for the present disclosure.

The normalized textual data is sent to the logical load balancer 18, which is composed of numerous computers to start to configure software pipeline process and balance the data loading into the opinion search engine 20. The opinion search engine 20 generates scores for the social media electronic messages and record the resulting scores at the production data storage aggregator 22. The production data storage aggregator 22 includes different types of databases, such as a cache database 34, an index database 36, and a relational database (e.g., Oracle) 38. A suitable commercial application of the cache database 34 is produced by Redis, a suitable commercial application of the index database 36 is produced ElasticSearch, and a suitable commercial application of the relational database 38 is produced by Oracle Corporation of Redwood Shores, Calif.

The relational database 38 stores the information such as the social media electronic messages and the computed scores, in tables that have relationship with one another. The index database 36 is configured to enable the opinion searches to be conducted more rapidly. The cache database 34 is configured to identify entities that exist in databases and associate the entities with a unique identifier, which enables quick query and query response actions. Entities are predefined search categories that can be real, such as singers and actors, or virtual, such as S&P 500 Index and Air Transportation. All the databases are exposed to the clients via the API 24. In one embodiment, the entity builder (also referred to as an “entity administrative server”) 28 enables human intervention to manipulate and test the scores by storing the revisions (or changes) in the document database 40. The revisions are pushed into production by the application server 42. Once the application server 42 can verify and confirm the data, then the application server 42 automatically forward the revisions to be incorporated into the production data storage aggregator 22.

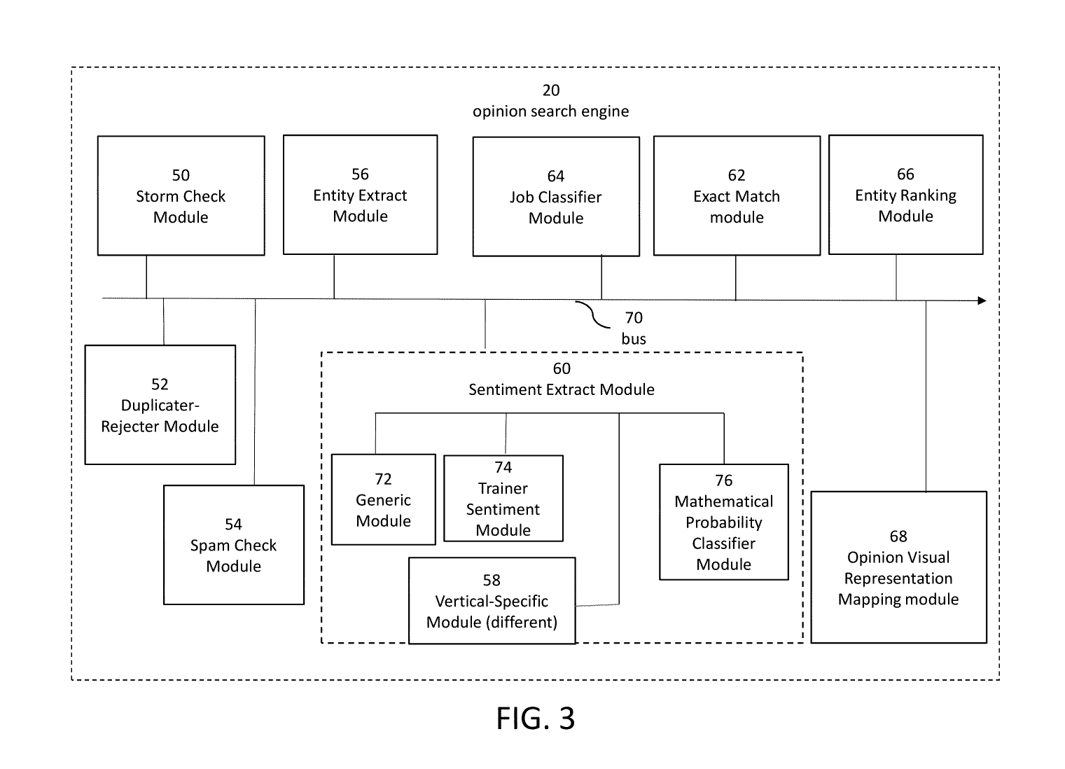

FIG. 3 is a software system diagram illustrating one embodiment of the opinion search engine 20 including a storm check module 50, a duplicate-rejecter module r, a spam check module 54, an entity extract module 56, a vertical-specific module 58, a sentiment extract module 60, an exact match module 62, a job classifier module 64, an entity ranking module 64, an opinion visual representation module 68, and a bus 70 coupling the various modules. The sentiment extract module 60 includes a generic module 72, a sentiment module 74, and a mathematical probability classifier module 76. When the normalized textual data is received by the opinion search engine 20, the storm check module 50 is configured to check the textual data that enters the opinion search engine and determines if the textual data matches the patterns of a Twitter storm, such as a sudden spike in activity surrounding a certain topic on the Twitter social media site. For additional details on storm detection, see U.S. nonprovisional application entitled “Method and System for Social Media Burst Classifications”, Ser. No. 14/062,746, owned by the common assignee and herein incorporated by reference in its entirety. The duplicater-rejecter module 52 is configured to seek and determine if the incoming data already exists in the system. As input social medial data crawled from different data sources are normalized, a unique signature representing the input social media data is created. The unique signature is used to identify if the same input data was seen earlier by the system 10. If the input social media data was in fact seen earlier, the duplicater-rejecter module 52 is configured to reject the input social media data. Otherwise, the input social media data is sent along to the next step in the data processing pipeline to classify input text.

The spam check module 54 is configured to analyze the textual data to see if a social media electronic message is a spam of contains spam, which refers to a commonly-used euphemism to describe irrelevant or inappropriate messages sent on the Internet to a large number of recipients. Spam often takes the form of indiscriminate advertisements, and other unwelcome, often automated communications. An example of the spam check module's output is shown here:

[{‘conf’: ‘800’,
‘engine’: ‘st:Spamvana’,
‘entity’: ‘NP’,
‘feature’: ‘st:SPAM’,
‘fields_used’: [{‘field’: ‘Body’,

‘field_range_end’: 239,
‘field_range_start’: 0}],

‘model’: ‘v.1.0.0.1’,
‘mood_score’: ‘x’,
‘rule_hits’: ‘bayesian rules’}]

The exact match module xx is concerned with unambiguously identifying an entity that occurs in the text. An example of the exact match engine's input is shown here:

ExactMatchEngine

token[ ] → {entityID, feature, mood} ← some fields can be missing
“Apple Computer Inc” → scoreObj: {EMEVer, ent:IDof(Apple),
{ }, { }}
#AppleComputerRocks → scoreObj: {EMEVer,
ent:IDof(Apple),”general”,+2}
@AppleComputer → scoreObj: {EMEVer,
entIDof(Apple),”sourceID”,{ }}
EME versioning is based on data model loaded.
So scoreObj: {EMEVer1.1, ScoreDateTimestamp,

EMEModel_ver2.2,EMERule_that_triggered:’Apple Computer Inc’,
entID, featureID, moodScore}

moodscore {floating pointnumber OR ‘x’ OR ‘m’ OR ‘u’}

number = moodscore to max 2 decimal prec (e.g. 1.23)e
x = not_scored
m = mixed
u = unknown

After processing by the exact match module, the output is provided as follows: Exact Match Engine output Example:

[{‘conf’: 1000,
‘engine’: ‘st:EME’,
‘entity’: u‘52fc335499c603f475c6a1a0’,
‘feature’: ‘NP’,
‘fields_used’: [{‘field’: ‘Body’,

‘field_range_end’: 186,
‘field_range_start’: 181}],

‘model’: ‘v.1.0.0.1’,
‘mood_score’: ‘x’,
‘rule_hits’: ‘cisco’},..]

The entity extract module 56 is configured to identify and tag with metadata the words that are known to exist in the system's relational database 38. To phrase it another way, the entity extract module 56 is configured to identify one or more nouns in a text streams, such as a person, place, or things to get tagged as an entity (while the sentiment extract module 60 is configured to assess other words in the text streams and how they relate to those entitles). For example, if “Apple Computer” exists in the relational database, when a textual data that contains the term “Apple Computer” enters the pipeline process, it will be tagged as containing a reference to “Apple Computer.”

The vertical-specific module 58 contains multiple entity extraction modules that are tuned for use in different vertical domains. The vertical-specific module 58 enables the system 10 to synthesize results from a broad number of taxonomic domains (collections of things), but then present those results in a coherent and easily understandable fashion. For example, consider a term that is difficult to disambiguate, such as “apple”. The term “apple” could refer to a fruit, a computer manufacturer, or a recording artist publisher. Three phrases that each contain a different embodiment of the term “apple” are: “I ate a red delicious apple”, “I love my apple macbook”, and “The Beatles published their music via apple”. In this example, the system would employ three different vertical-specific engines. The term “vertical” indicates a logical grouping of related items. One such grouping would be fruit, such as “apples, oranges and pears”. A second grouping would be computer manufacturers, such as “Apple, Lenovo and Dell”. A third grouping would be recording artist publishers, such as “Arista, Universal Music, and Apple Records”. The system would then take each input phrase, and seek out clues that indicate which phrase belonged to which vertical. In this example, the verb “ate” implies that the “apple” in the first phrase belongs to the fruit vertical, while the noun “macbook” implies that “apple” in the second phrase belongs to the computer manufacturers vertical. Finally the word “Beatles” implies the “apple” in the third phrase refers to the recording artist publisher vertical. By having each vertical-specific engine tuned to a particular vertical, (fruit, computer manufacturers, recording artist publishers), the system can more easily and effectively identify the appropriate context for each entity, and classify it correctly.

The sentiment extract module 60 further includes a generic module 72, trained sentiment module 74, and a mathematical probability classifier module 64. The sentiment extract module 58 is configured to differentiate and isolate the sentiment from the textual data, also referred to as an ensemble methodology, where sentiment extract module 60 is configured to run multiple types of analysis simultaneously on the same target data and then generating a score for each of these functions. The sentiment extract module 60 processes a piece of textual data through each of the submodules 72, 74, 76. The generic module 60 is configured to provide the first pass of the textual data and access the sentiment. Next, the data passes through the trained sentiment module 62, which is configured to make a more accurate assessment of the textual data's sentiment. For example, the phrase “That album was super bad” can be assessed as a positive sentiment by the trained sentiment module 74. Finally, the textual data passes through the mathematical probability classifier module 76 where the textual data is configured to classify the textual data into different topics based on existing mathematical probability theory. Each of the three modules that the textual data passes through generates a separate score. All the scores for each textual data are combined and synthesized into a super score and stored on the relational database 38. The sentiment extract module 60 is intended as an illustration, which can be modified, subtracted, added, integrated by one of skilled in the art.

The job classifier 64 is configured to identify job ads by scraping for job listings and determined whether a particular textual data actually contains reference or description of a job listing. The job classifier 64 is configured to look for certain patterns and certain word patterns that are prevalent in job listings. The entity ranking module 66 is configured to prioritize the amount in the payload by ranking the different groups of information. The opinion visual representation mapping module 68 is configured to gather all the information and textual data relevant to the client's query and transform the information into a visual graphical representation for display on a computer display.

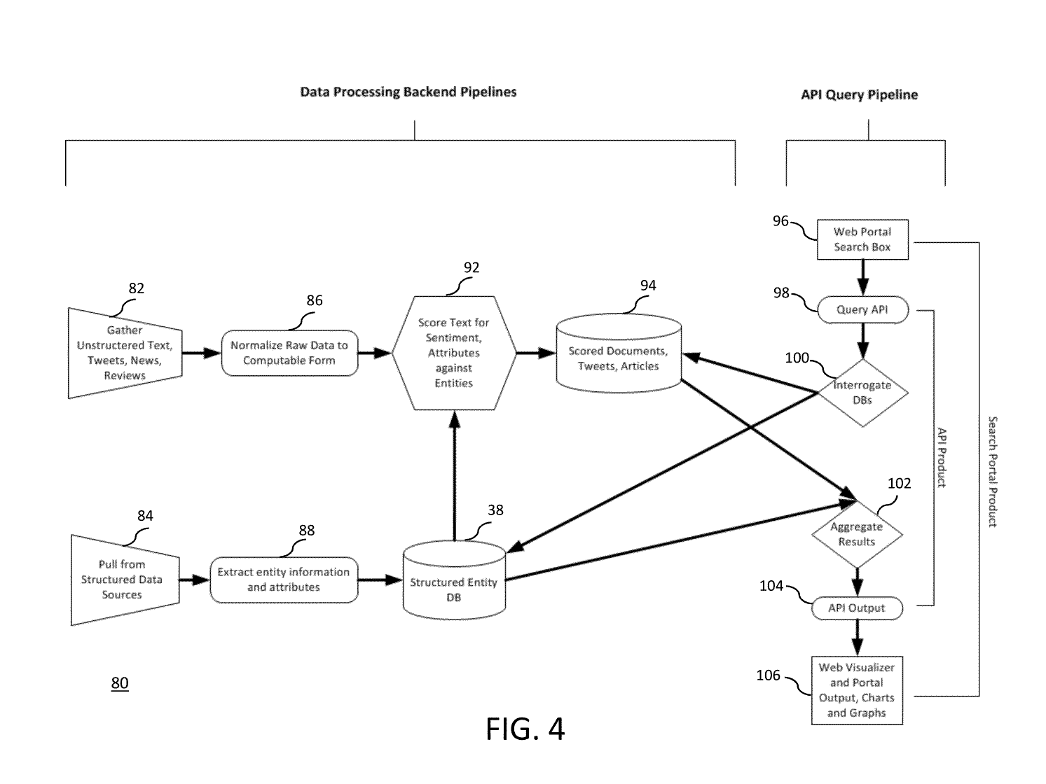

FIG. 4 is a block diagram illustrating the process flow 80 of data processing of structured and unstructured social media electronic messages through the opinion search engine and query processing through the API. At step 82, the system 10 is configured to gather and receive text, tweets, news, reviews, and other sources from various social media websites and other sources and detect that these electronic messages or information are unstructured. At step 84, the system 10 is configured to gather or pull structured data from various social media websites and other sources. Unstructured data collection is the collecting of raw, unstructured text from voluminous of online public and private data sources. The raw text contains unidentified topics (or entities), such as people, places, things, etc., as well as contextual clues about human opinion towards those entities. An example of such text would be a micro-blogging post from a Twitter® user exclaiming “I love Justin Bieber's new album”. The system 10 also collects data from simple syndication (RSS) feeds, and streaming application programming interfaces (API's). Each data source generally contains textual data in many different formats. For example, RSS Feeds are typically implemented as extensible markup language (XML) pages, while the custom crawlers are designed to parse HTML, which is a different formatting standard. In order for the system to process this varied, inconsistent, unstructured and semi-structured data, at step 86, one objective is to make all the data consistent or have the same format, by have the system 10 normalize (or transform) unstructured data from one unstructured format to structured data with a standard format. After normalizing the data into a consistent format for use by the system 10, a copy of the raw (un-normalized) data is also retained for future reference.

In one embodiment, normalized data may contain specific information for use by the system, including input_body, created_date, unique_id, unique link to a web page, source site, etc. In addition, the system 10 collects the author_name, location, type, and gender if this information is contained or can be successfully inferred from the raw text input. These attributes are desirable, but not required for use by the system 10. Location is normalized to a most granular description available, and if possible reduced to precise latitude and longitude coordinates.

The code snippet below shows what the unstructured data looks like when the code is received by the system 10. Each new piece of text is classified as an item_object.

item_object
{

#input as captured
input_raw : {

#raw fields from source (may be empty if norm-ing process is
“perfect”)

}

After this raw input is gathered by the system, it is automatically normalized into the following format:

#engines only operate on normalized data here:
input_normed: {

input_id: <ID> #assigned ID from moodwire database
input_title: string,
input_body: string, #raw review text, tweet, crawled article, supplied
data etc
source_url : string,
source_id : <ID>, #mw assigned source ID
date_source : date_code_int #seconds since 1970, date as spec'd by
source
date_received : date_code_int, #seconds since 1970?, date
processed by dB
author_source_id: string or <ID> # source's ID (eg twitter handle)
author_mw_id : string or <ID> #moodwire assigned ID if available
storm_prefix_sig: <string>
storm_prefix_sig_crc64: <64bit_int> #crc64 of storm_prefix_sig
location_txt: string (profile city, etc) #if available
location_lat_long: (GPS coords) #if available

} #end of input_normed

At step 88, the system 10 extracts the entity information and attributes from each structured data, where the structured entity information is stored in the database at step 38. At step 92, the system 10 receives a first stream of social media electronic messages that have been normalized, and a second stream of social medial electronic messages where the entity information has been extracted and stored. The system 10 assigns a score to each textual data for sentiment and attributes against different entities. For identifying one or more entities social media electronic messages that are sourced as unstructured data, the raw unstructured text input is elucidated by comparison with known, structured text, thereby identifying the entities contained within the normalized unstructured data. At step 94, the system 10 stores the scored documents, tweets and articles. Using the above Bieber example, by comparing what is known about Justin Bieber the celebrity in the structured database, (i.e.—the fact that he just released a new album), with the incoming unstructured data being collected by his fan's tweet, the system can infer that the fan's Twitter® post is referring to Justin Bieber the celebrity singer, and not some other, lesser known person who is also named Justin Bieber. The system 10 adds data to associate the formerly unstructured data with the structured data because the system 10 determines that this particular tweet refers to Justin Bieber, the celebrity. By tagging the incoming tweet as such, the system 10 now establishes that these two data elements are related to one another. This synthesis enables further enrichment, including the scoring of human opinion pertaining to the entities as they occur in the unstructured text—by examining the tweet further, the system 10 infers that this fan has a favorable opinion of Mr. Bieber's new album, and then give that a numerical score. Because the word “love” was used, instead of some less emphatic term, such as “like”, the system might assign this tweet a score of +2 in favor of Mr. Bieber's new album, instead of +1. Finally, the system can also use human sampling and oversight of the automated process to assure the quality and relevance of the data. A human operator, who reviews this example tweet would likely affirm that it is in fact referencing Justin Bieber the singer/celebrity. When multiple humans agree with the software program's assessment, a baseline can be established for training the software system in a manner that reinforces greater accuracy and precision in subsequent analyses, thus improving the system over time using a variety of statistical machine learning and natural language processing techniques.

Other than unstructured data, the system 10 also collects structured data from voluminous online public and private sources regarding known, well-defined entities. An example of such structured data would be collecting information about Justin Bieber's age and height from http://www.wikipedia.org, the public online encyclopedia, automatically via their application programming interface (API). Structured data sources are gathered in the structured entity database before undergoing similar scoring procedure as the unstructured textual data. The structured data store is extended and enhanced through the gained new knowledge, from the raw unstructured text by labeling all newly discovered topics (entities) with metadata from the structured database, as well as scoring each mention of these known entities for human sentiment. In this example, this tweet now contributes a +2 towards collected public opinion about Mr. Bieber's new album, thus enhancing the favorability of human opinion regarding the album.

After the social media opinions and associated entity relationships have been determined and added to the system 10, the results of this processing and enrichment are then presented to the end-users of the system using two different methods, via an API, as well as via a unique user interface. The API enables other automated software programs to consume this enriched information and add it as an input to their processing and calculations. Through the web portal search box 96, a query term processes through the Query API 98, which is configured to interrogate the databases 100 for information that may be associated with the query term. The Query API search result will be aggregated at step 102 and exported via the Query API Output 104 and then deliver the various web visualizer, portal output, charts, and graphs to the computer display at step 106, where the web portal search box originated from.

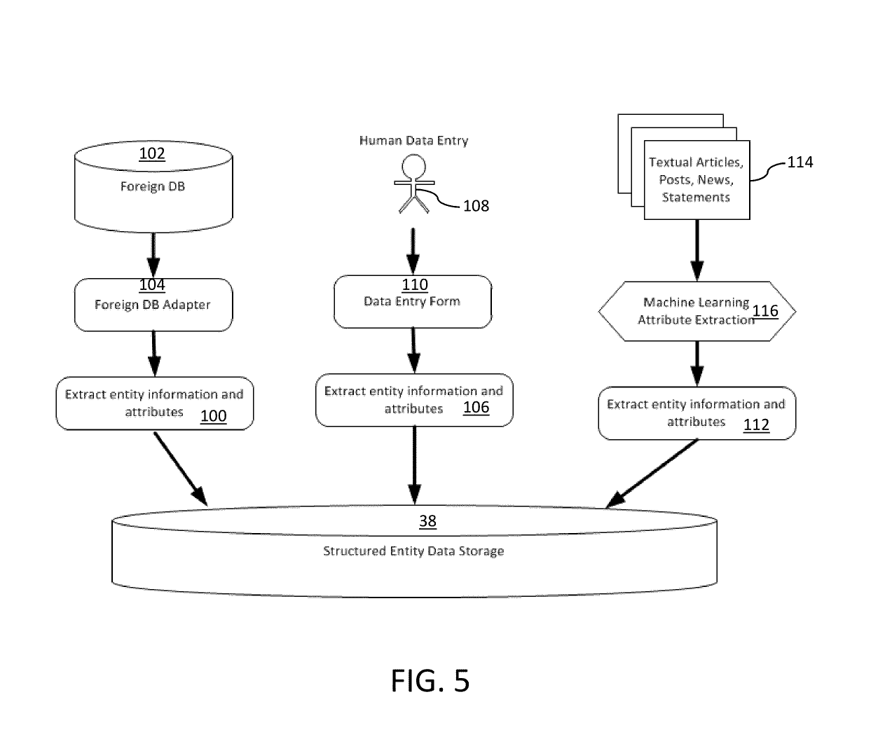

FIG. 5 is a flow diagram illustrating the structured entity data storage 38 which receives multiple entity information and attributes from various sources. In this embodiment, the structured entity data storage 38 receives a first source from the extracted entity information 100 through a foreign database 102 and a foreign database adaptor 104, a second source from the extracted entity information 106 through a human data entry 108 and a data entry form 110, and a third source from the extracted entity information 112 through textual articles, posts, news and/or statements 114 and a machine learning attribute extraction 116. In the first source, the foreign database adapter 104 extracts the entity information and attributes 100 from the foreign databases 102. The second source come from the human data entry 108 when a user records the information on the data entry form 110 from which the system 10 extracts the entity information and attributes. In the third source, the entity information and attributes 112 can also be extracted from textual articles, posts, news, statements, and others 114 through the machine learning attribute extraction 116. The extracted entity information and attributes 110, 16, and 112 are stored on the structured entity data storage 38.

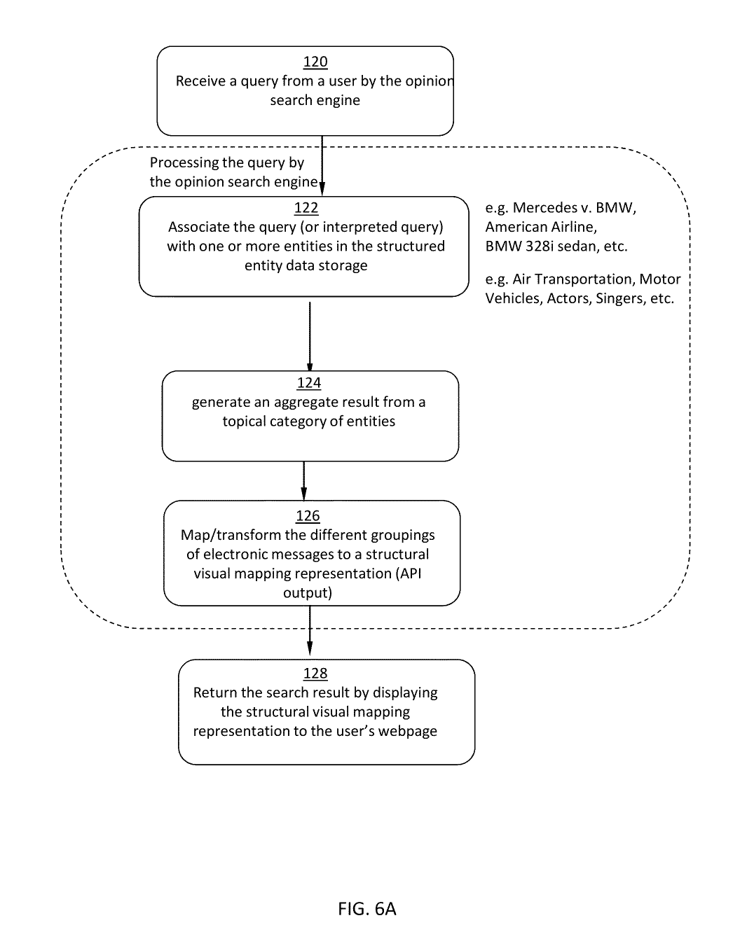

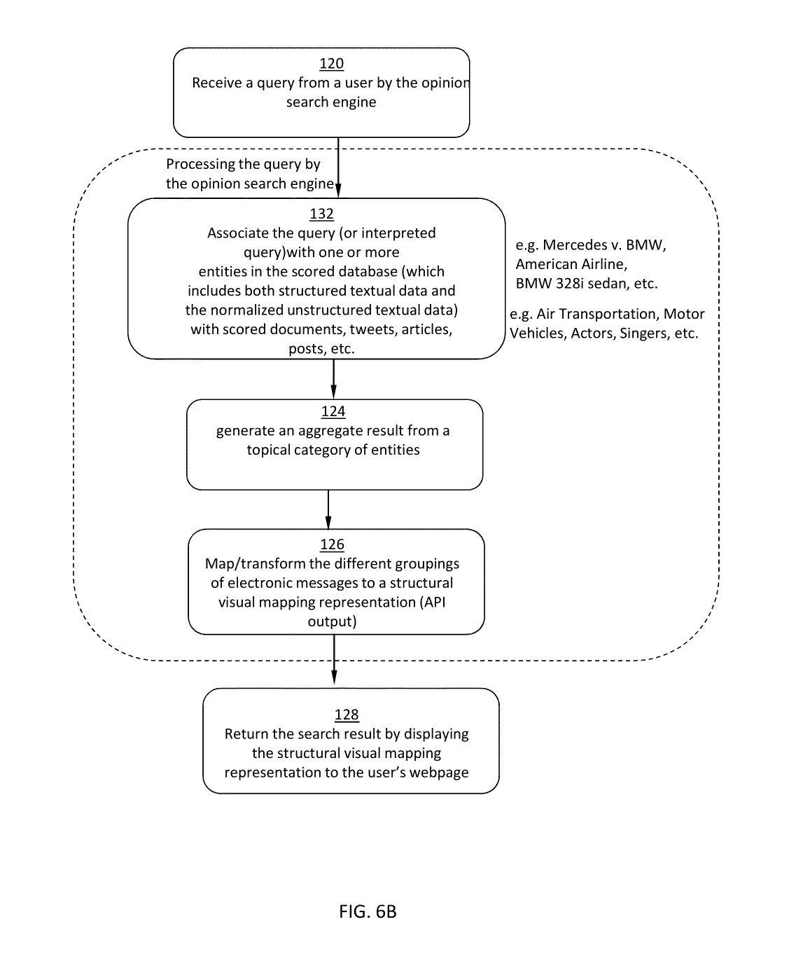

FIG. 6A is a flow diagram illustrating the process flow of the opinion search engine for horizontal opinion processing to generating a structural visual mapping representation. At step 120, the opinion search engine 20 is configured to receive a query from a user on the webpage through the Internet or other wireless communication medium. In other embodiment of the invention, the query can be from other sources, such as a mobile application, and not limited to webpage. At step 122, the opinion search engine 20 is configured to associate the received query to one or more entities in the structured entity data storage, such as, for example, American Airline or BMW 328i sedan, and the normalized unstructured textual data. The query can also be a comparison query, such as between different automobile brands, Mercedes verses BMW. Optionally, the system 10 can take the query with a certain term, or a phrase or a sentence, and interpret the meaning of the query for associating with one or more entities in the structured entity data storage 38. At step 124, the opinion search engine 20 is configured to generate an aggregate result from a topical category of entities, such as Air Transportation, Motor Vehicles, Actors, etc. At step 126, the opinion search engine 20 is configured to transform or map the different groupings of electronic messages to a structural visual mapping representation to generate an API output and then return the result to the user's webpage by displaying the structural visual mapping representation at step 128.

FIG. 6B is a flow diagram illustrating the process flow of the opinion search engine for horizontal opinion processing to generating a structural visual mapping representation. At step 120, the opinion search engine 20 is configured to receive a query from a user on the webpage through the Internet or other wireless communication medium. In other embodiment of the invention, the query can be from other sources, such as a mobile application, and not limited to webpage. At step 132, the opinion search engine 20 is configured to associate the query (or interpreted query) with one or more entities in the scored database (which includes both structured textual data and the normalized unstructured textual data) with scored documents, tweets, articles, posts, etc. Optionally, the system 10 can take the query with a certain term, or a phrase or a sentence, and interpret the meaning of the query for associating with one or more entities in the structured entity data storage 38. At step 124, the opinion search engine 20 is configured to generate an aggregate result from a topical category of entities, such as Air Transportation, Motor Vehicles, Actors, etc. At step 126, the opinion search engine 20 is configured to transform or map the different groupings of electronic messages to a structural visual mapping representation to generate an API output and then return the result to the user's webpage by displaying the structural visual mapping representation at step 128.

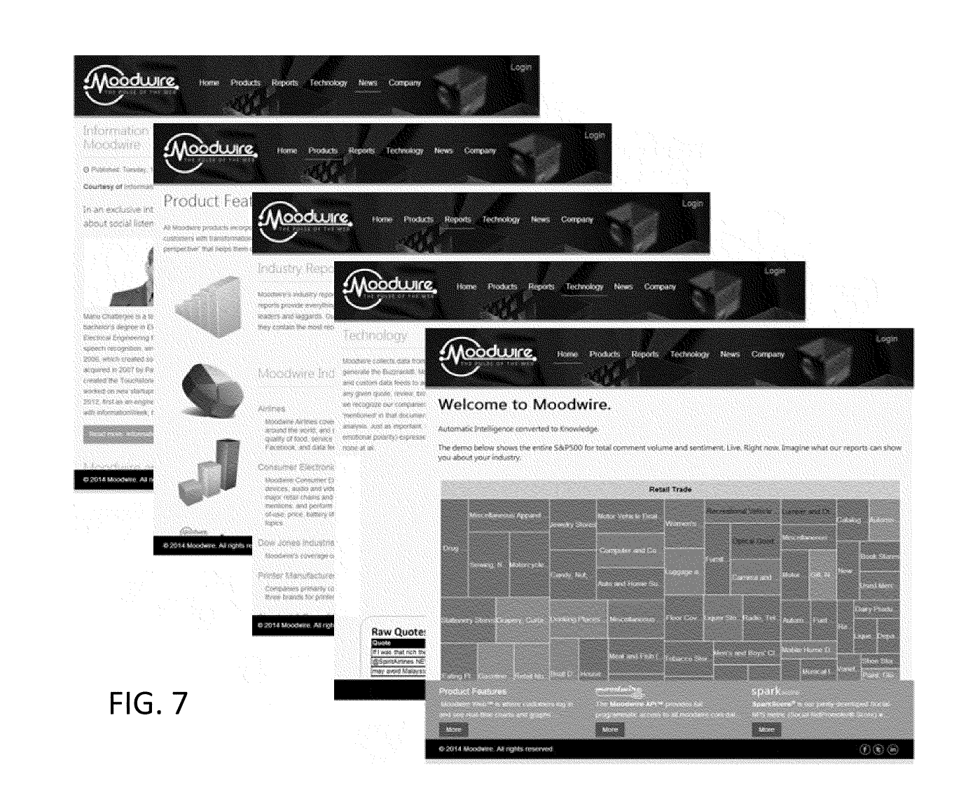

FIG. 7 is a graphical diagram illustrating sample webpages that are available for viewing at the assignee's website, www.moodwire.com, as supplied by Moodwire Inc. (Moodwire) located in Menlo Park, Calif. Under the Home page at Moodwire, a user entered a query of S&P500 through the opinion search engine 20 and may receive a return with the volume and sentiment of the entire S&P500 index. The Moodwire website also provides a user a wide variety of web resources, such as the Technology page, the Reports page, the Product page, the News page, and others.

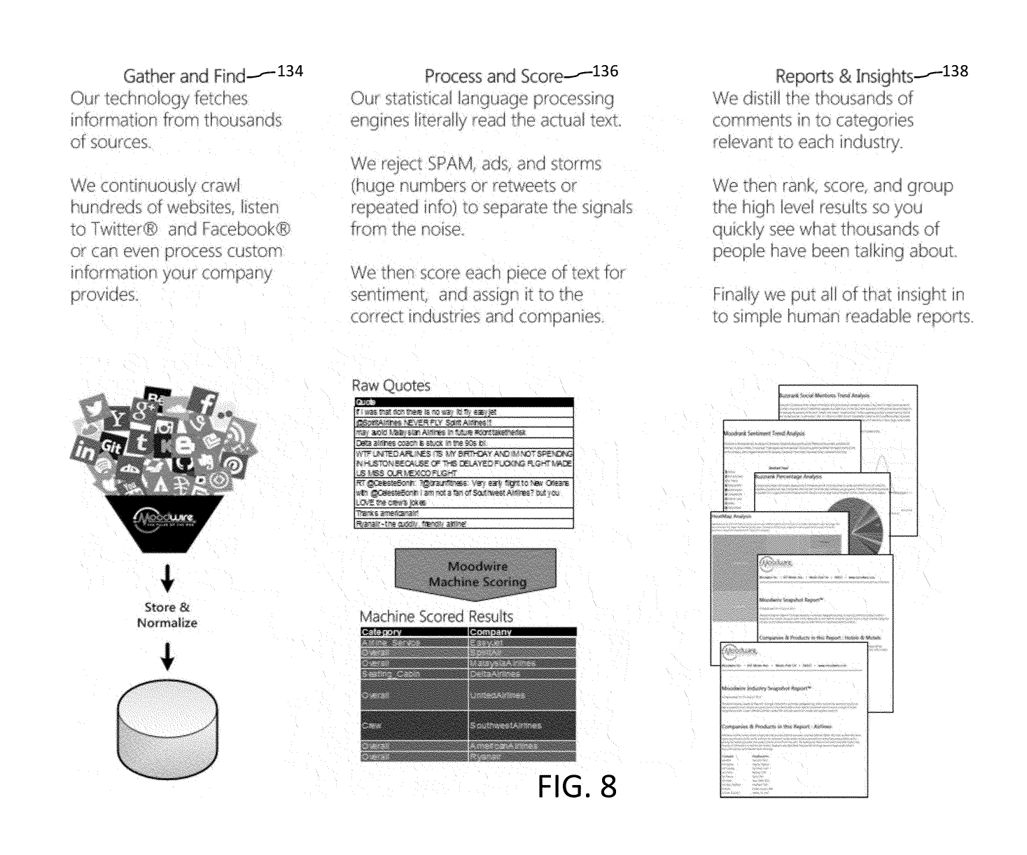

FIG. 8 is a graphical diagram that provides one illustration in the main partition processes of the opinion search engine 20. In this example, the opinion search engine 20 is partitioned into (1) Gather and Find 134, (2) Process and Score 136, and (3) Reports and Insights 138. During the Gather and Find process 134, the opinion search engine 10 is configured to fetch information from thousands of sources and continuously crawl hundreds of websites over Internet for the updated social media electronic messages. The opinion search engine 10 can also be configured to process custom information or social media posts tailored to a specific company. The opinion search engine 10 is configured to normalize the gathered the social medial electronic messages and store the normalized information in the data storage aggregator (or a database) 34. In the Process and Score step 136, the opinion search engine 20 includes a statistical language processing that is capable of reading the actual text of social medial electronic message. The opinion search engine 20 is configured to reject certain information, such as spam, advertisements, and storms (e.g., huge numbers or retweets or repeated info) to separate the useful signals from the noise. The opinion search engine 20 is further configured to score each piece of social media electronic messages or textual data for the content of sentiment bias (toward positive sentiment or negative sentiment), and assign a suitable metatag to associate with an entity category (e.g., a correct industry, or a correct company). Under the Reports and Insights process 138, the opinion search engine 20 is configured distill the thousands of social media comments into categories relevant in each industry. The opinion search engine 20 is then configured to rank, score and group the a suitable level of results as a reflective and accurate portrayal of the mass public opinion posts and sentiments on a particular entity, a particular industry, or multiple entities relative to one another, as presented in visually transformed structured summary on a computer display.

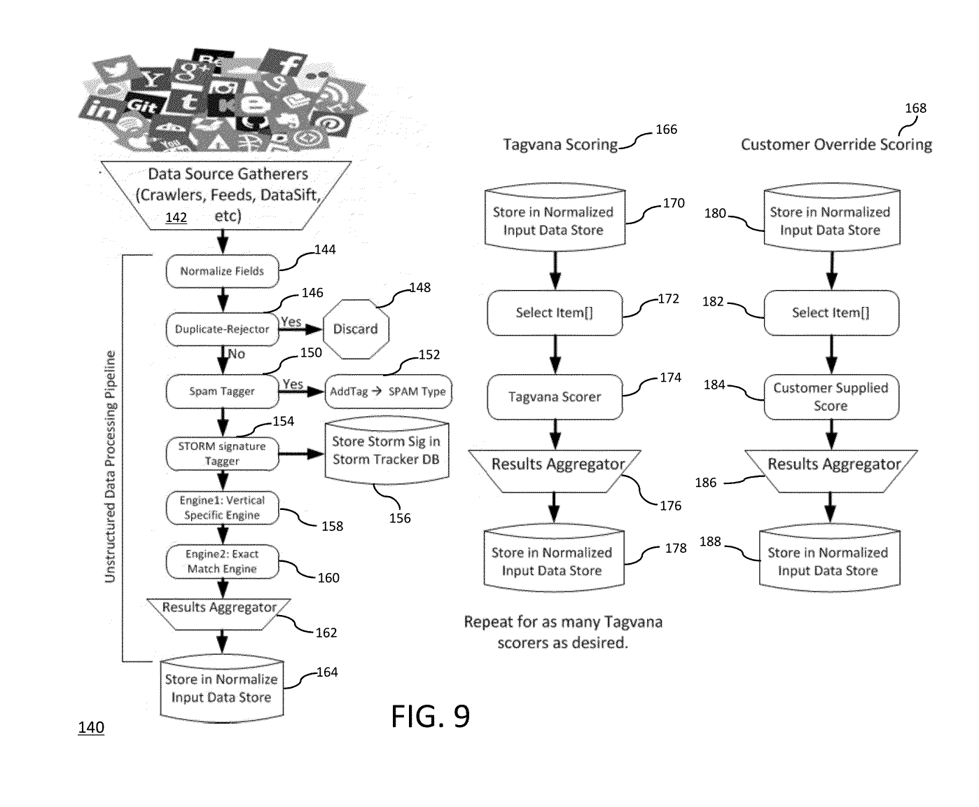

FIG. 9 is a flow diagram 140 that illustrates the process flow of the opinion search system 10 (or the opinion search engine 20) in normalizing and scoring unstructured social media electronic messages. In this embodiment, at step 142, data source gatherers 16 in the opinion search system 10 collects the raw quotes from a wide variety of social media sites or data sources, such as Twitter, Facebook, Google+, etc. At step 144, the opinion search engine 20 is configured to normalize the fields of the received unstructured textual data, and transform the unstructured textual data into structured textual data with a specified and standard data format. At step 146, the duplicater-rejecter module 52 is configured to reject and remove any duplications among the received social media electronic messages, the textual data that is considered be a duplicate to another textual data will be discarded at step 148. At step 150, the spam tagger module (or spam checker module) 54 is configured to detect and identify spam messages and tags all spam textual data as spam type. The detected spam textual data are then discarded from further processing at step 152. At step 154, the STORM signature tagger 50 is configured to detect, identify and tag Twitter (or Twitter-like) storm pattern in the textual data, and at step 156, the STORM signature tagger 50 adds the Twitter storm patter to the Storm Tracker database. Optionally and preferably, multiple automated engines independently generate score for each piece of textual data that passes through, including the vertical-specific module 58 at step 158 and the exact match module 62 at step 160. At step 162, the opinion search system 10 aggregates the results from the prior process steps into aggregated results. At step 164, the opinion search system 10 stores the normalized input data and the aggregated results in the production data storage aggregator 22.

The opinion search engine 20 may also score the textual data by other methodologies, such as by Tagvana Scoring method 166 and the Customer Overriding Scoring method 168. In Tagvana Scoring method 166, the opinion search system 100 retrieves the unstructured textual data that have been normalized at step 170, select a particular piece of normalized textual data at step 172, score the piece of normalized textual data at step 174, repeat the scoring process for as many as of the normalized unstructured data as desired, generate an aggregated results at step 176, and store the aggregated results with scores in the data storage aggregator 22 at step 178. In the Customer Overriding Scoring method 168, the opinion search system 100 retrieves the unstructured textual data that have been normalized at step 180, select a particular piece of normalized textual data at step 182, score the piece of normalized textual data as supplied by an external source such as by customers at step 184, repeat the scoring process for as many as of the normalized unstructured data as desired, generate an aggregated results step 186, and store the aggregated results with scores in the data storage aggregator 22 at step 188.

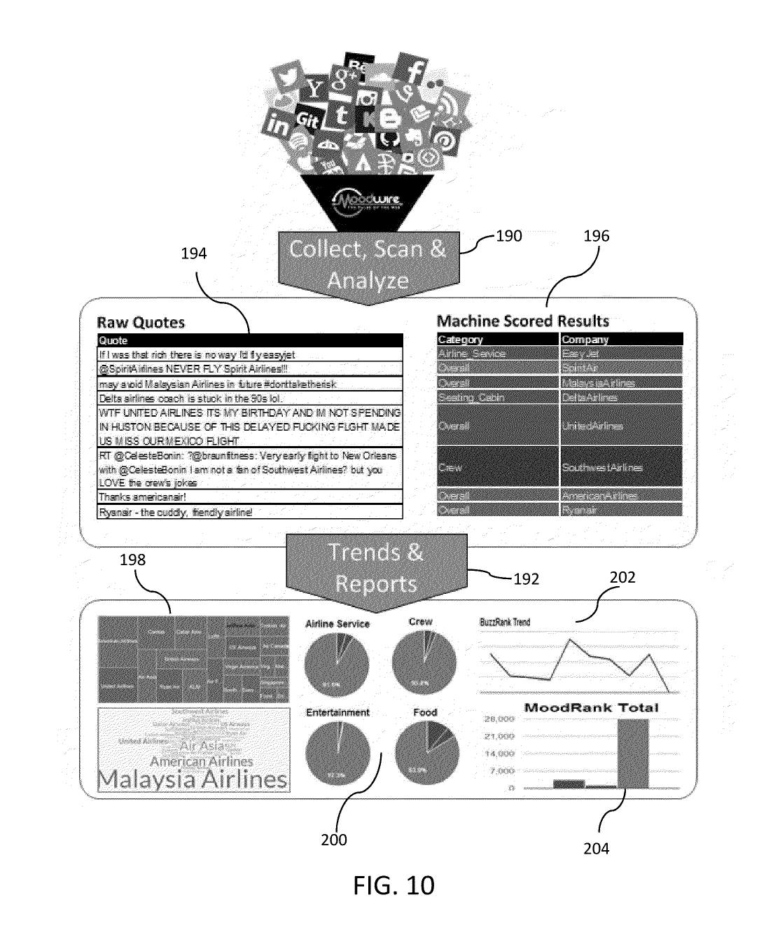

FIG. 10 is a graphical diagram that provides an illustration of the opinion search system in (1) collecting, scanning, and analyzing with raw quotes and machine scored results at step 190 and (2) generating trends and reports with graphical representations at step 192. In this example, the opinion search system 10 collects the unstructured social media electronic messages (e.g. textual data) relating to the airline industry from different social media sites, such as Twitter, Facebook, Google+, and others, as shown in the raw quotes 194 with sample raw quotes like “If I was that rich there is no way I'd fly easejet”, “Thanks americanair!”, and “Ryanair—the cuddly, friendly airline!”. In other embodiments, the system 10 collects both unstructured and structured social media electronic messages. Next, the opinion search system 10 is configured to associate each social media electronic message to one or more categories, and score each unstructured social media electronic message (also referred to in some instances as raw quotes). The opinion search engine 20 in the opinion search system 10 analyzes the sentiment of each unstructured social media electronic message. The opinion search system 10 generates machine scored results 196 by category and company with color coding to indicate the degree of positive sentiments or the degree of negative sentiments. When a user submits a query to the opinion search engine 20, the system 10 performs computations to generate visual representations for a word cloud 198, pie charts 200 (by airline service, crew, entertainment, and food), a buzzrank trend 202, and a moodrank total 204, as representative of big data summary and real-time analysis of synthesized public opinions and sentiments for one or more of the selected entities (e.g., airline) in the query.

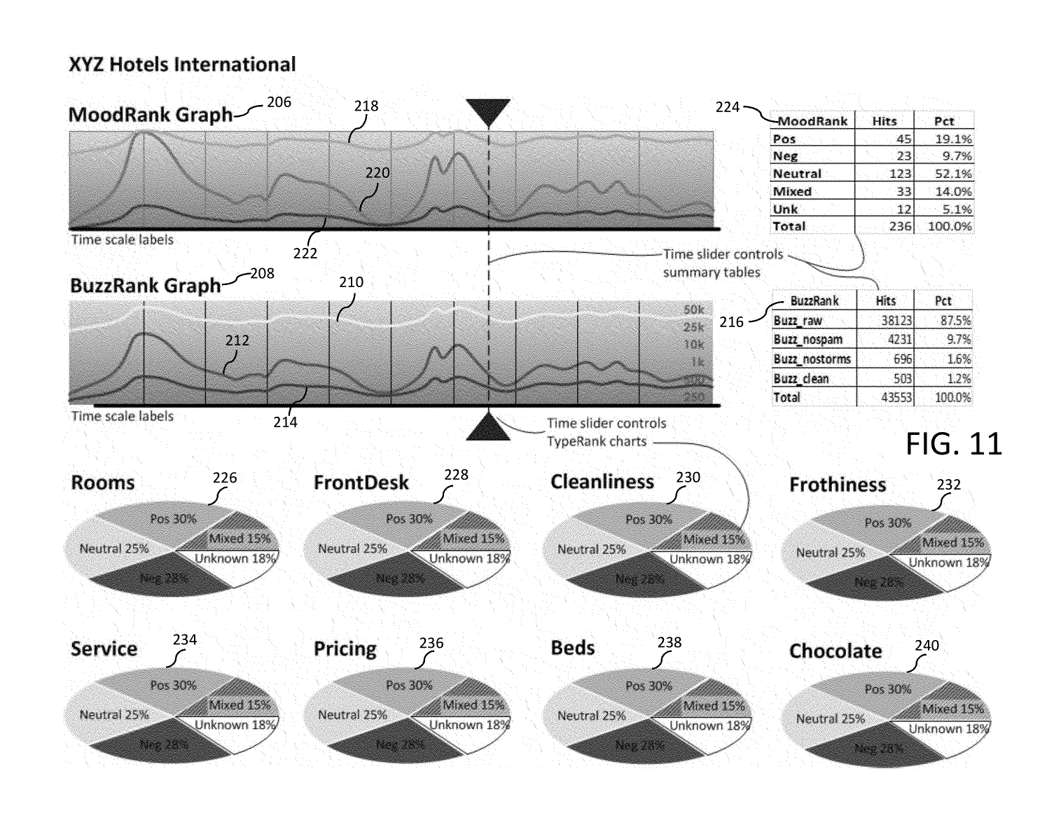

FIG. 11 is a graphical diagram illustrating sampling of synthesized public opinions in correlated MoodRank Graph 206 and BuzzRank Graph 208 for a particular hotel brand (referred to here as “XYZ Hotels International”). The BuzzRank Graph 208 shows three sampling graphical curves 210, 212, 214, where a first graphical curve 210 illustrates a higher amplitude (or buzz) with a more sustaining buzz over time, while the second curve 212 depicts amplitude or buzz fluctuations that are lower than the first graphical curve 210, and the third curve 214 resembles anemic characteristics with relatively low buzz compared to the second graphical curve 212 and the first graphical curve 210. A BuzzRank table 216 classifies social media electronic message into one of the four categories: Buzz_raw, Buzz_nospam, Buzz_nostorms, or Buzz_clean, and the corresponding calculated percentage of category type.

The Moodrank Graph 206 shows three sampling graphical curves 218, 220, 222, where the first graphical curve 218 illustrates a higher sustainable amplitude over time, while the second curve 220 shows a more amplitude fluctuation relative to the first graphical curve 218, and the third graphical curve 222 has a lower amplitude with anemic fluctuation compared to the second curve 220 and the first curve 218. A Moodrank table 224 classifies social media electronic messages into one of the five categories: Pos(itive), Neg(ative), Neutral, Mixed, and Unk(nown), with the corresponding calculated percentage of each category type.

Additional classifications and other types of matrices in performing data analytics on the social media electronic messages are possible, which can be extended into the different kinds of TypeRank charts on the sentiments or opinions of XYZ Hotels International. These various charts summarizes the matrices and the opinion search system 10 computes the percentages of the social media electronic messages to reflect positive, negative, mixed, neutral, or known opinion toward the XYZ Hotels International regarding the Rooms 226, FrontDesk 228, Clealiness 230, Frothiness 232, Service 234, Pricing 236, Beds 238, and Chocolate categories 240. The adjustment on the time slider control of the MoodRank graph 206 and BuzzRank graph 208 affect the computed percentages for displaying on the respective summary tables and TypeRank charts.

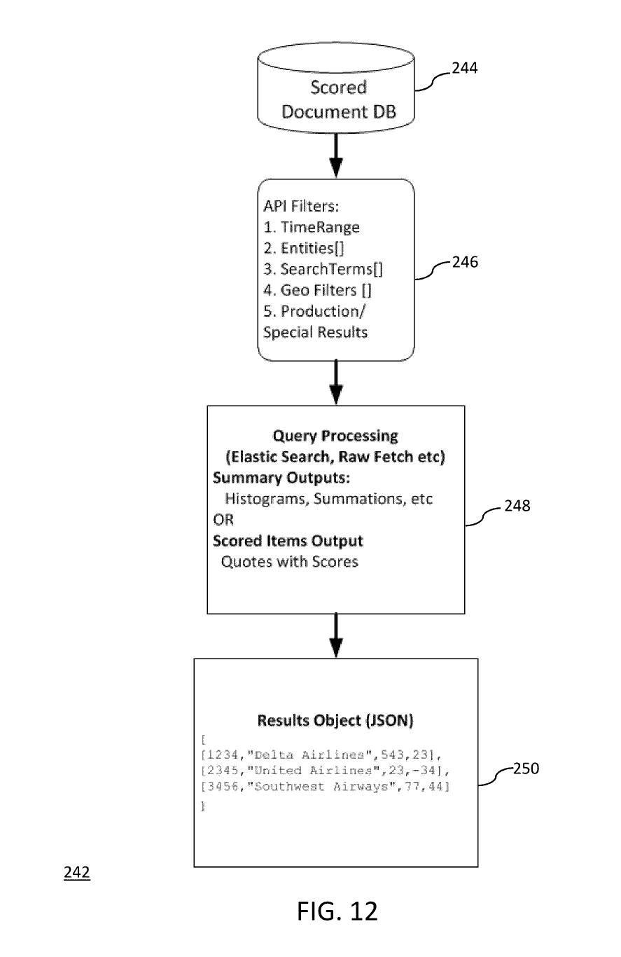

FIG. 12 is a flow diagram illustrating the process flow 242 of the query API pipeline procedure. At step 244, the opinion search system 10 stores the scored information in the data storage aggregator (or database) 22. Once a query term is entered on the web portal, at step 246, the opinion search system 10 processes the scored documents from the database 22 through various API filters, including TimeRange, Entities, SearchTerms, Geo Filters, and Production/Special Results. The API filters separates out the information in the document database that is not relevant for the query term, and leave only the relevant information for the output. At step 248, the opinion search system 10 processes the data through query processing, such as elastic search, raw fetch, etc., where the API generates the histograms, summations, entity metadata, relationships, and other summary outputs. Alternatively, if the summary outputs are not generated, then the scored items output is generated. As a result of the query API pipeline procedure, at step 250, the opinion search system 10 produces results object (BON) with ID, names, scores, and various other associated metadata for generating for an API output.

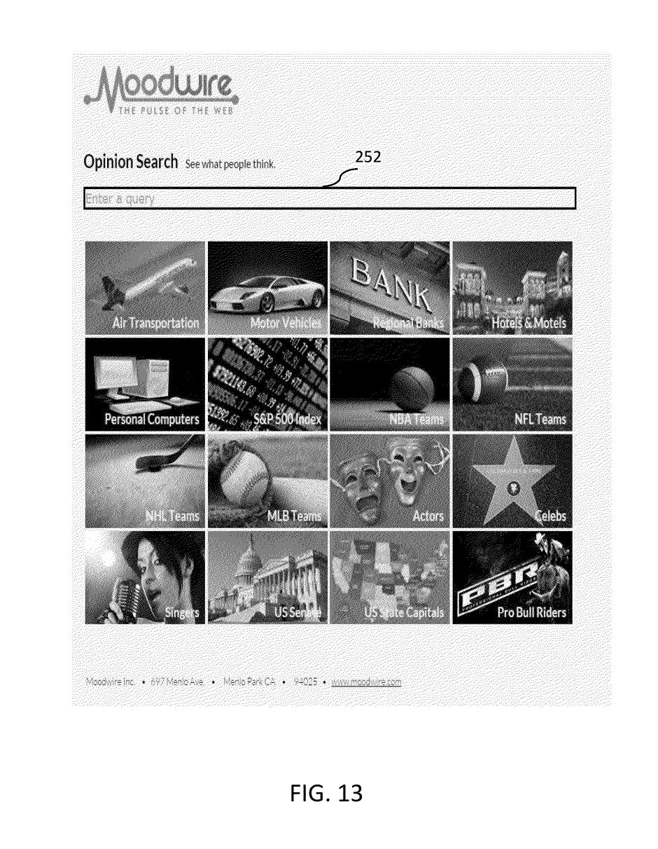

FIG. 13 is a graphical diagram illustrating an example of the opinion search interface screen 252 on a webpage as hosted by Moodwire Inc. In this example, the opinion search system 10 by Moodwire Inc. provides a search bar in which a user can access the web portal and enter a query for conducting an opinion search through the Internet to assess the public opinion (somewhat akin to polling public opinions except the process here is conducted through a computer search engine) on a particular topic, or comparative entities. Intended as a user friendly function, some topical categories placed underneath the search bar provides some suggested topics that the user may consider in forming a search query, such as airline transportation, motor vehicles, regional banks, hotels & motels, personal computers, S&P 500 Index, NBA teams, etc., are available as clickable block icons that can quickly allow the user to see the sentiment of that specific common topic.

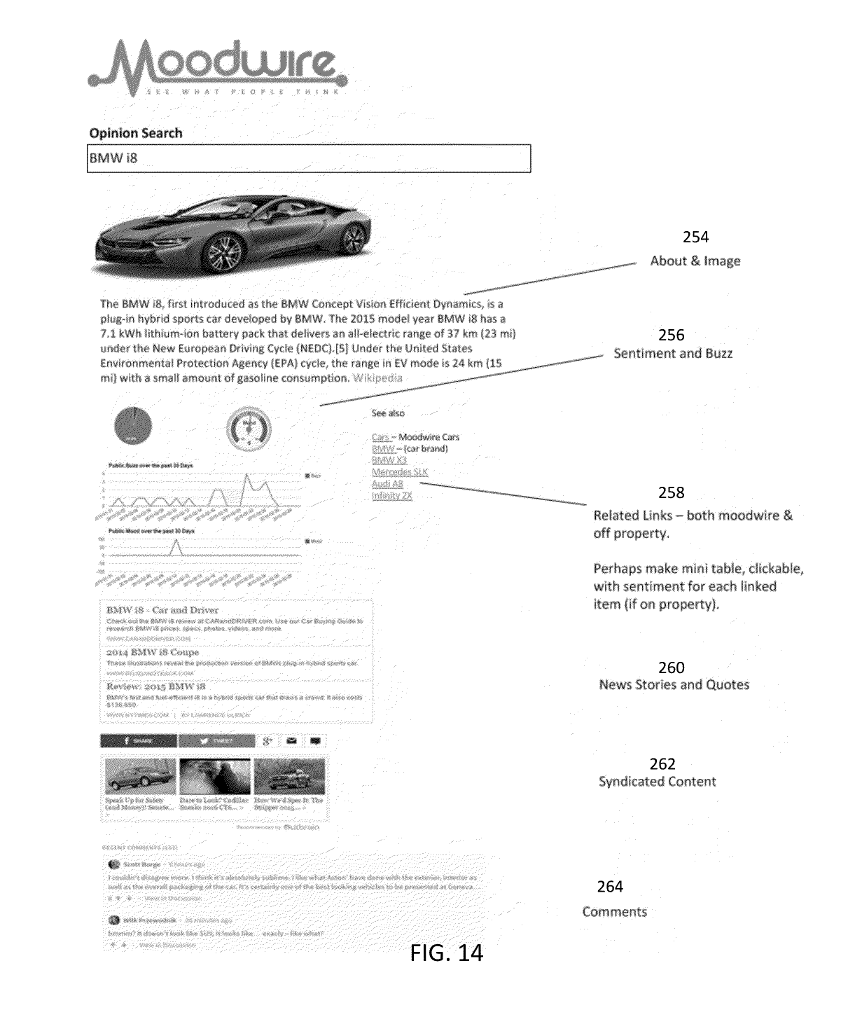

FIG. 14 is a graphical diagram illustrating one embodiment of an aggregated result generated by the opinion search engine 20 with a topic image 254, sentiment and buzz 256, related links (presentable in a mini table format) 258, news stories and quotes 260, syndicated content 262, and comments 264. In this example, when “BMW i8” is entered as a query, opinion search engine 20 is configured to process, return and display an image of the BMW i8 vehicle and a short introduction paragraph from Wikipedia. The opinion search result page can also display the sentiment and buzz of the vehicle, with two-dimensional graphs and charts to show the relative sentiment and relative buzz over time. Alternatively, variations or modifications of the two-dimensional graphs and charts are also contemplated within the spirits of the present invention, as well as three-dimensional representations of the sentiment and buzz characteristics. Another section on the opinion search result page displays topics related to BMW i8, such as cars in general, BMW the manufacturer, other BMW car models, and competing manufacturers' car models may also be displayed on the result page. The related topics table may contain clickable hyperlinks to either Moodwire database or other webpages. In addition, the opinion search result page can have a new stories and quotes section that shows the latest online reviews or news articles that references BMW i8. A syndicated content section displays user generated contents from Twitter, Facebook, Google+, and other social media sites. Furthermore, the opinion search result page can display comments by users from various online forums and communities that discuss about BMW i8. The opinion search result page in this example is intended to show one illustration, and does not limit the present disclosure to precise sectional comments, where modifications, additions, subtractions may be practiced without departing from the spirits of the present disclosure.

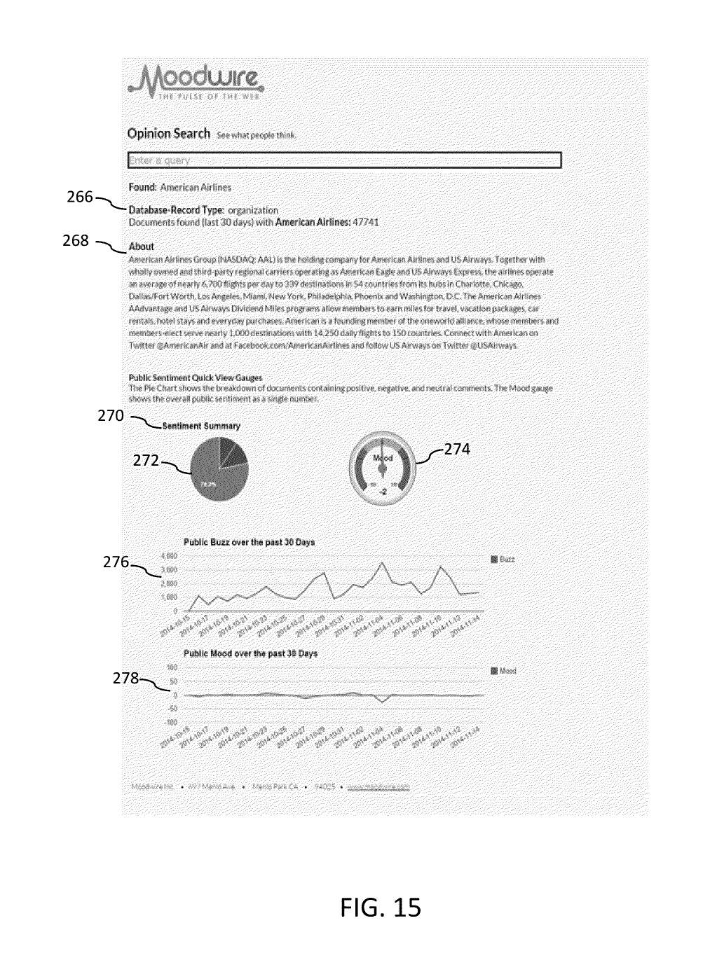

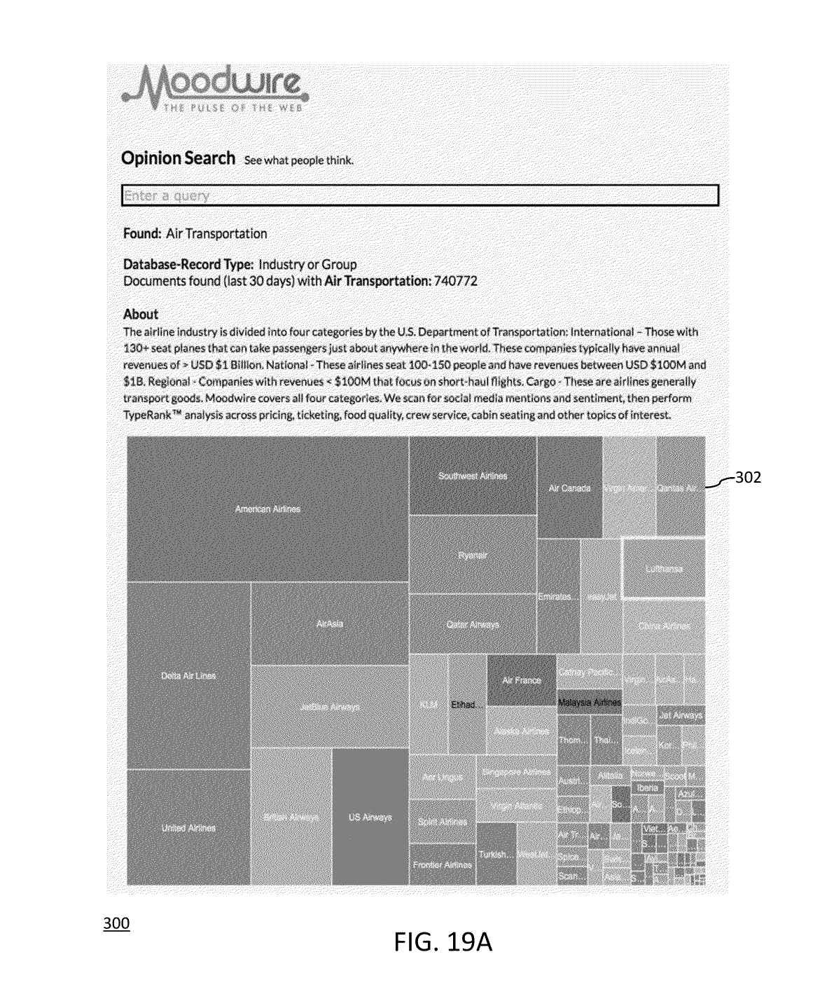

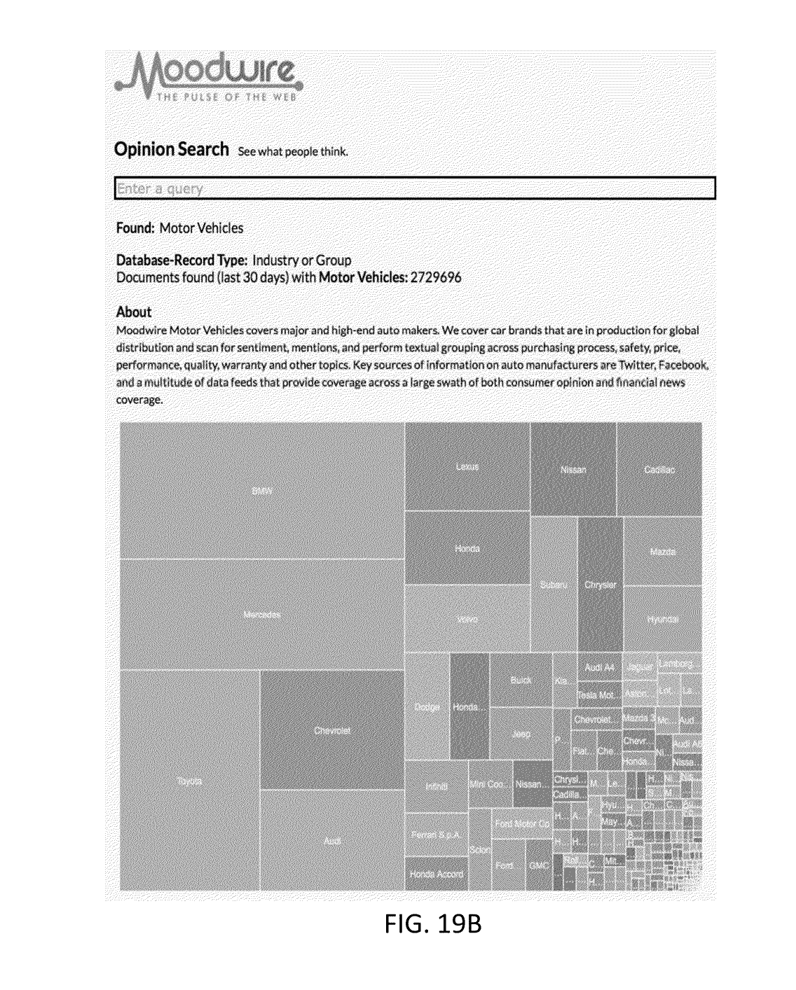

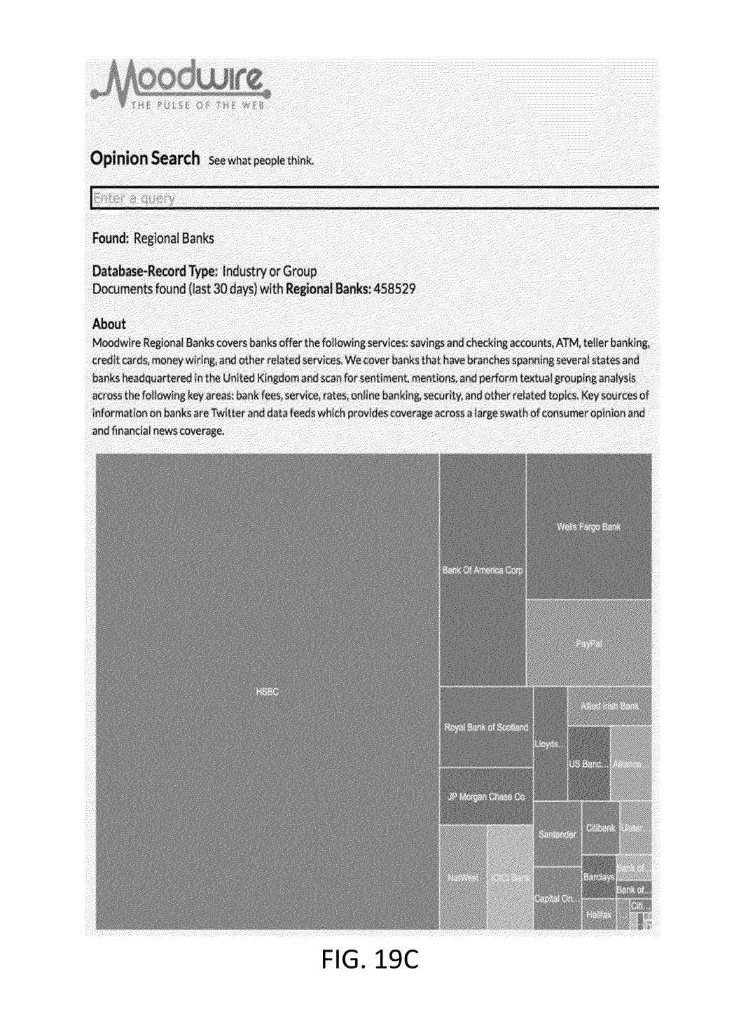

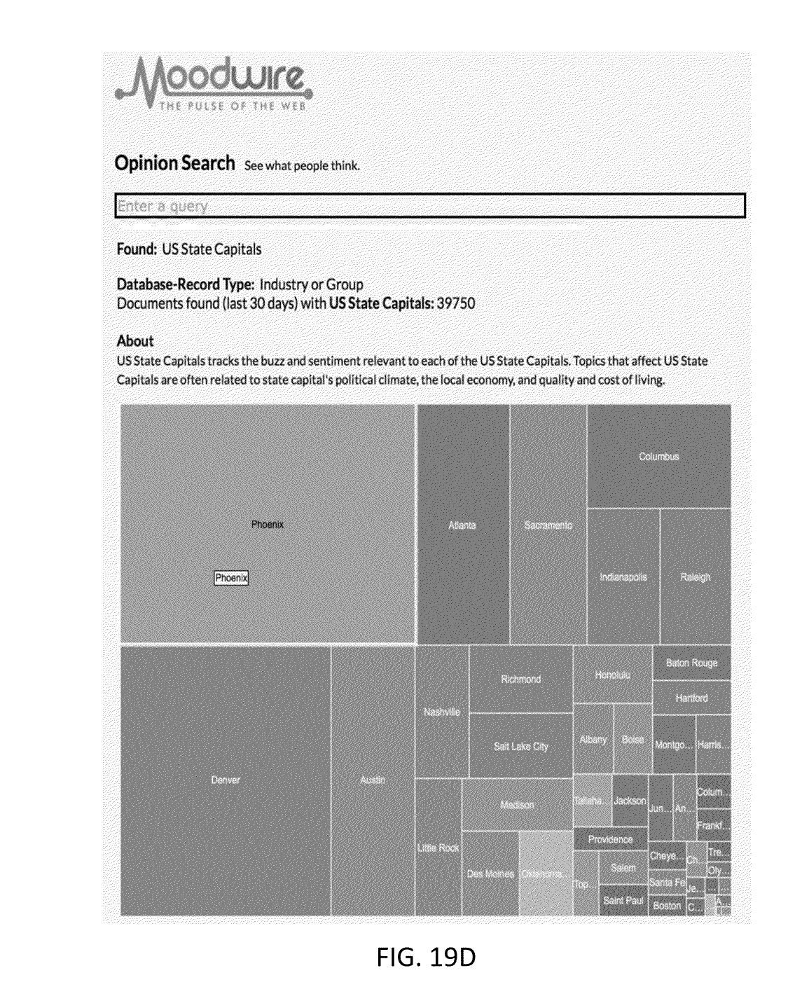

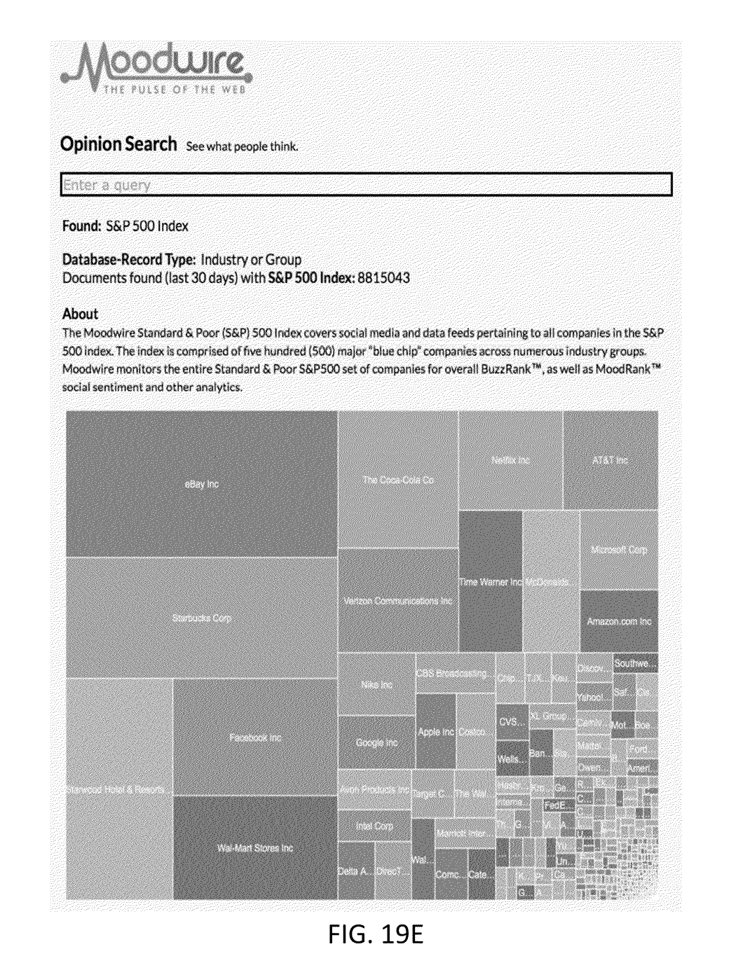

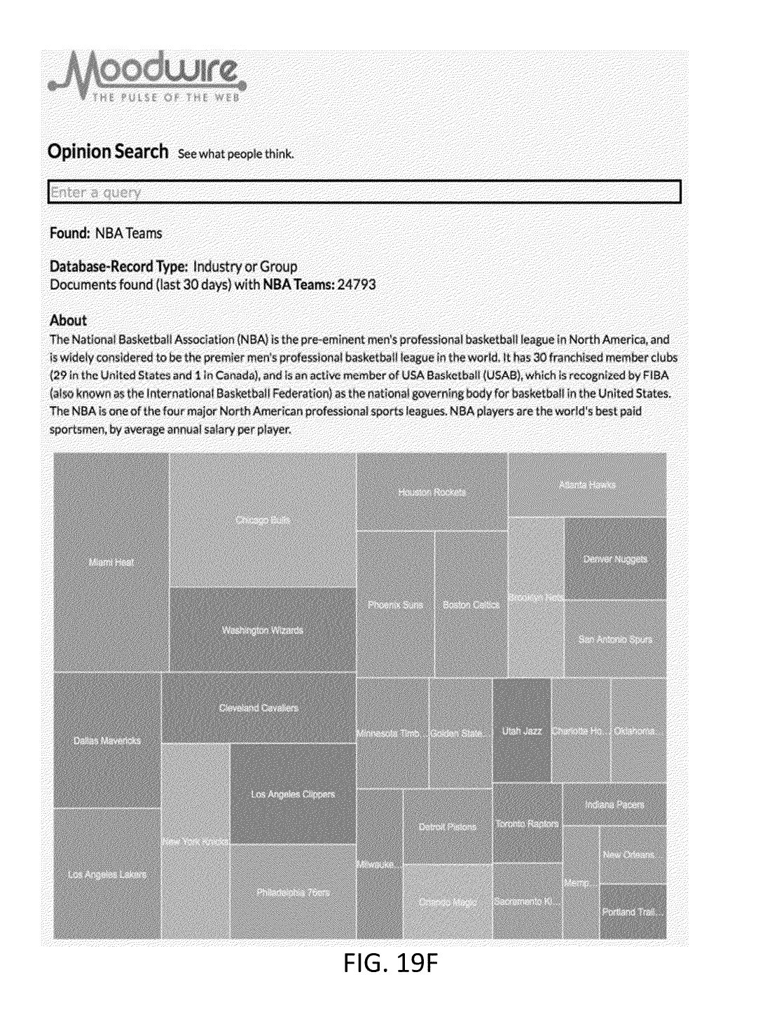

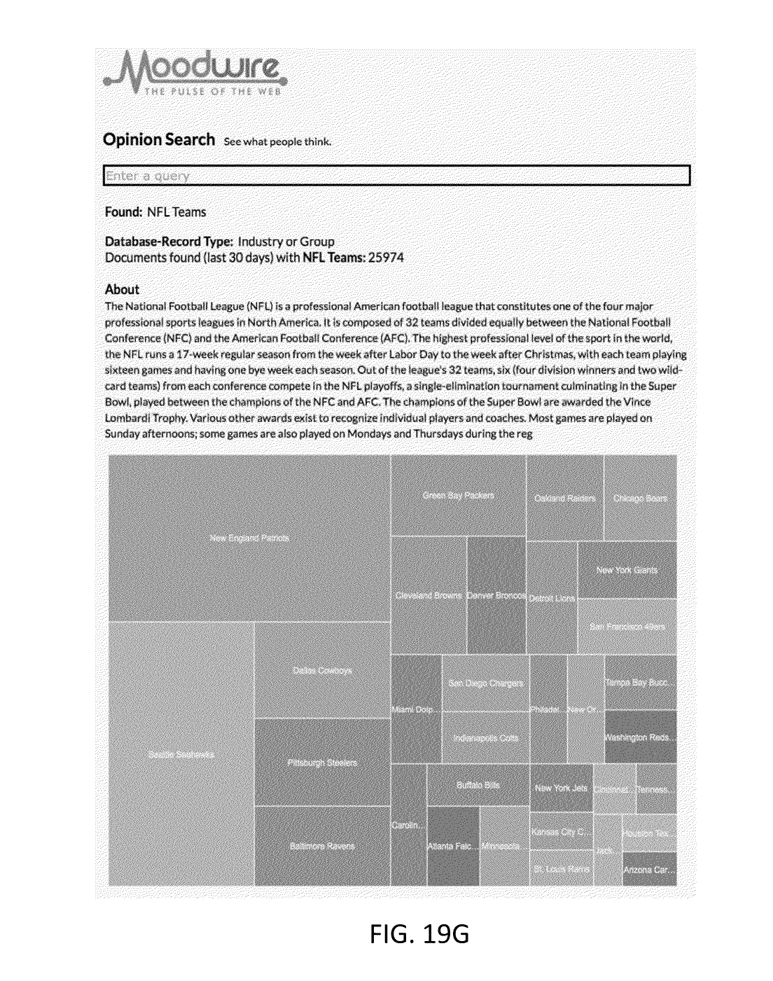

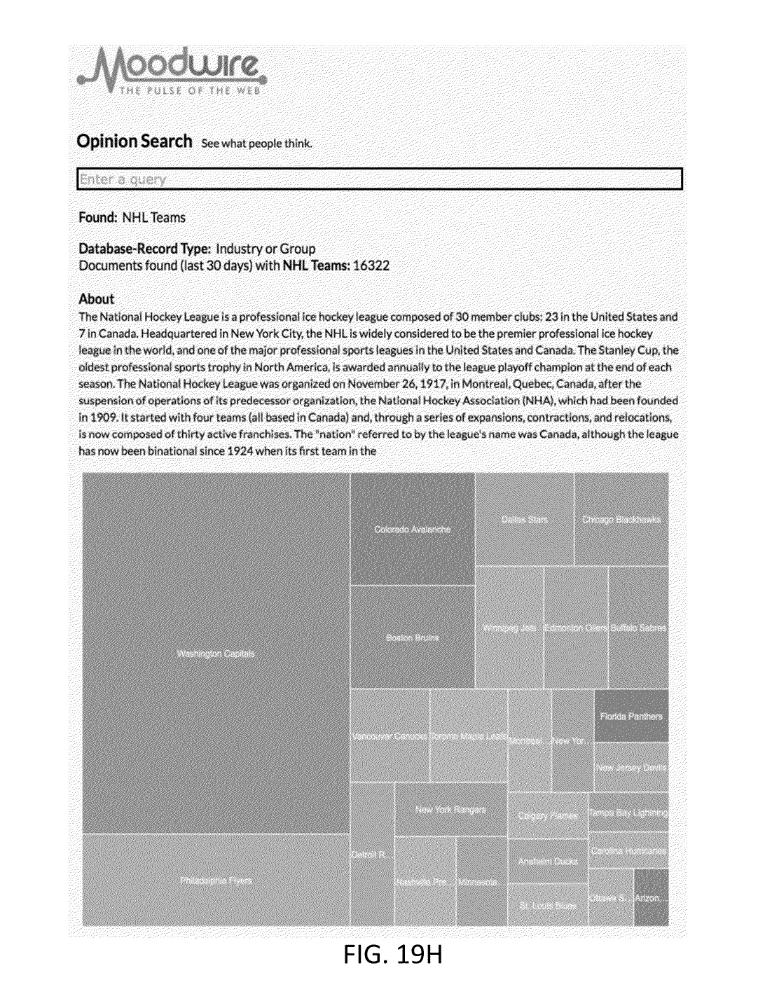

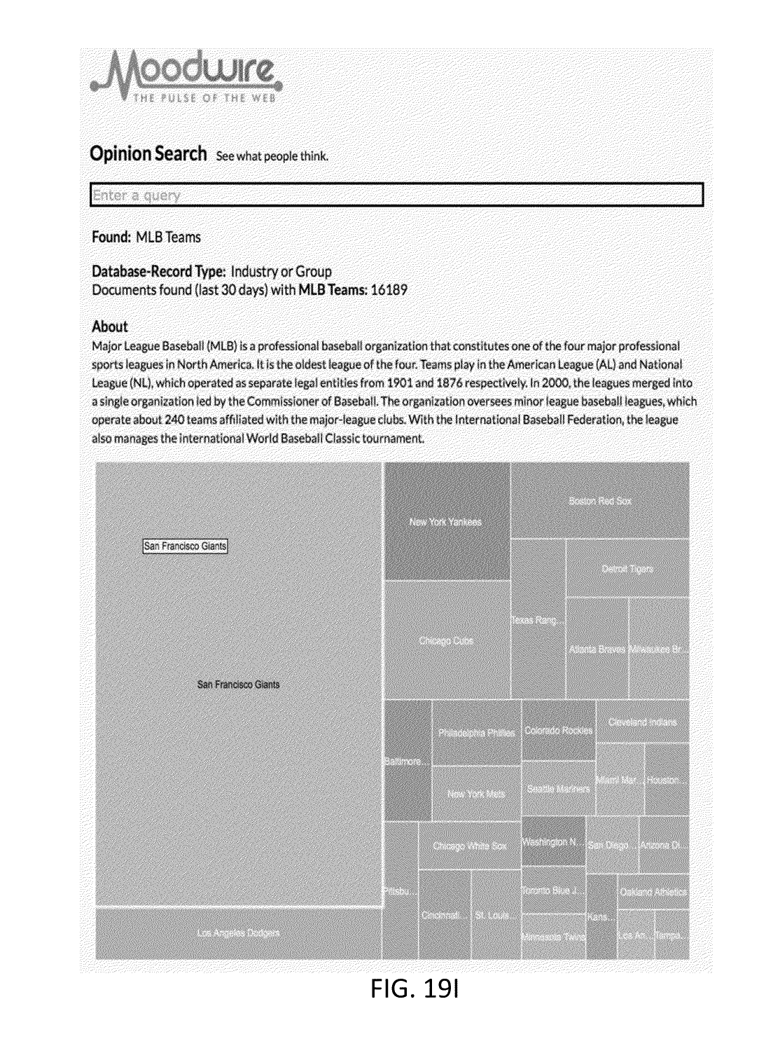

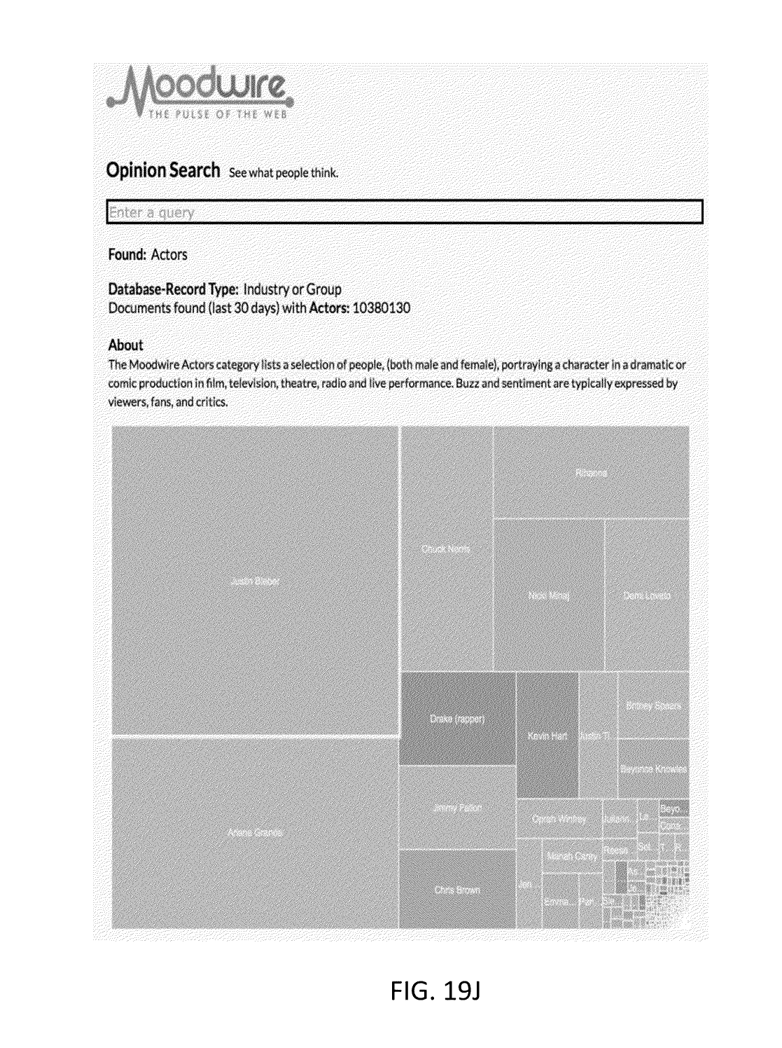

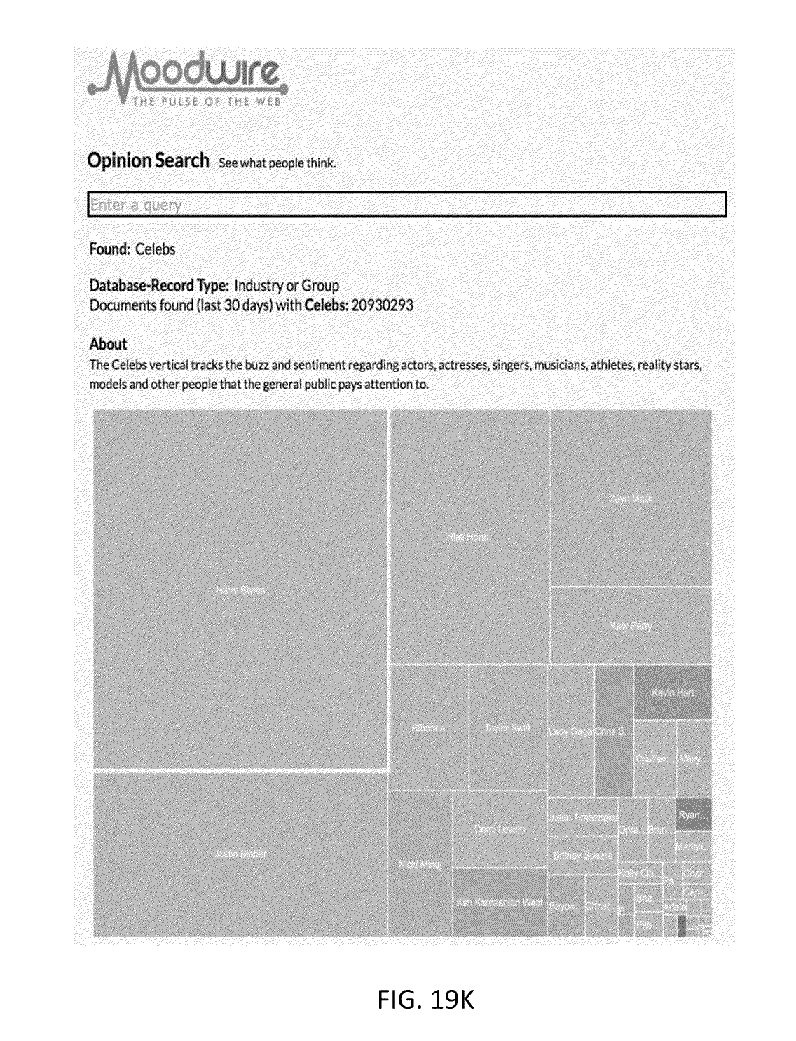

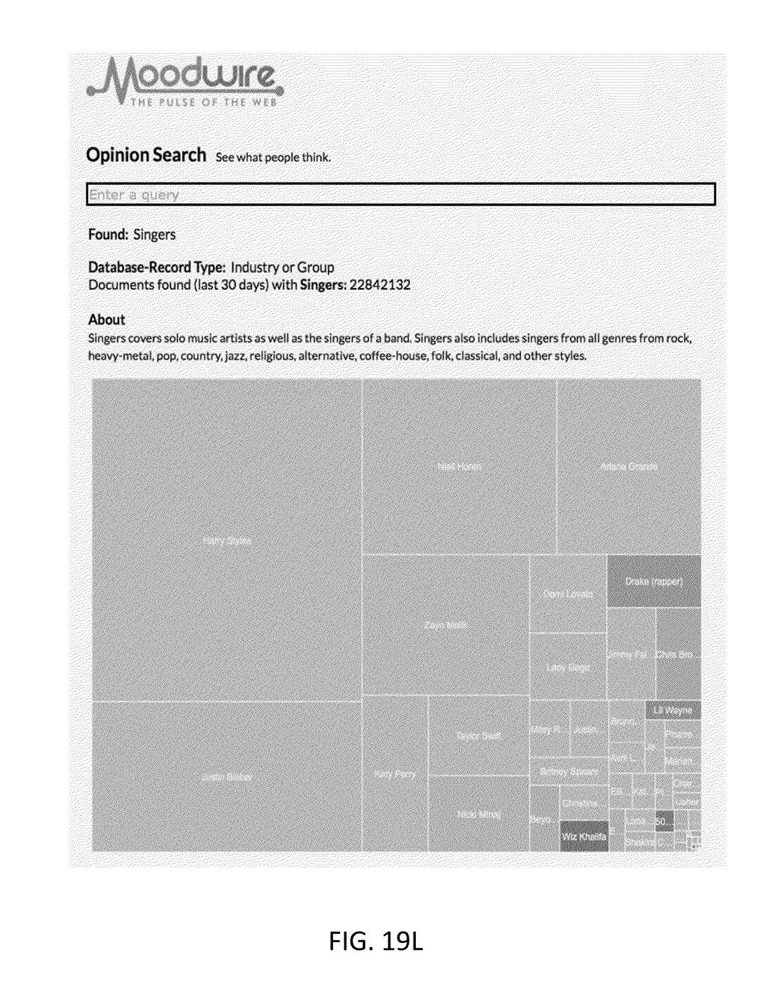

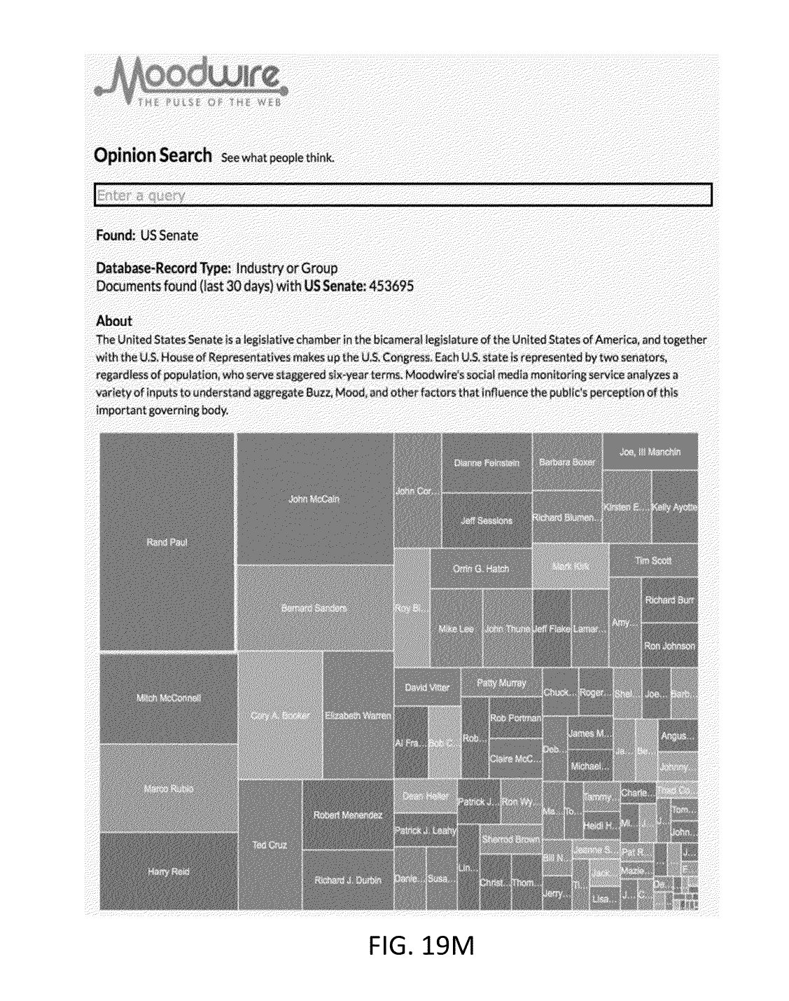

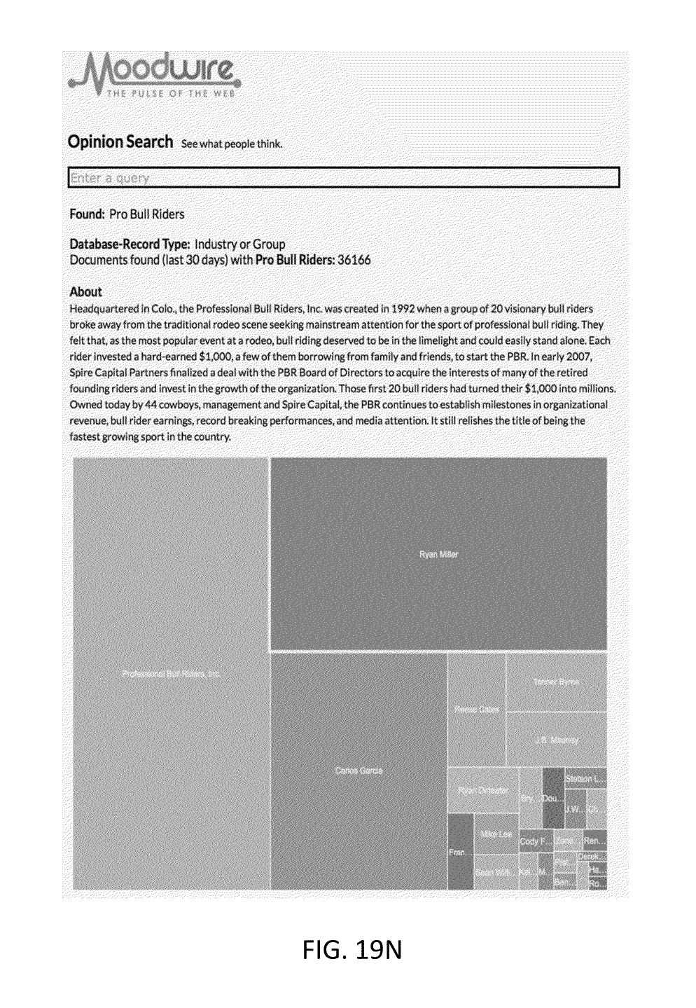

FIG. 15 is a graphical diagram illustrating an example of the opinion search result displayed with the sentiment summary, public buzz and public mood over a time period. In the search bar as shown in FIG. 13, the user enters the search query of “American Airlines”, which returns the transformed visual representation as illustrated in FIG. 19A. When the user clicks in the top left region with the text “American Airlines” in FIG. 19A, the resulting page displayed is shown in FIG. 15. The record type and the number of documents 266 associated with the search query is displayed toward the top, with the general information 268 immediately follow. A sentiment summary 270 of the search query is displayed below the general information. The sentiment summary contains one pie chart 272, one mood gauge 274, and two line charts 276, 278. The pie chart details the breakdown of documents related to the search query by positive sentiments, negative sentiments, or neutral sentiments. The mood gauge summarizes the overall public sentiment (mood) and display as a single number on the gauge. One of the line charts tracks the public buzz on the entity for the past thirty days, and the other line chart tracks and displays the public sentiment on the entity for the past thirty days.

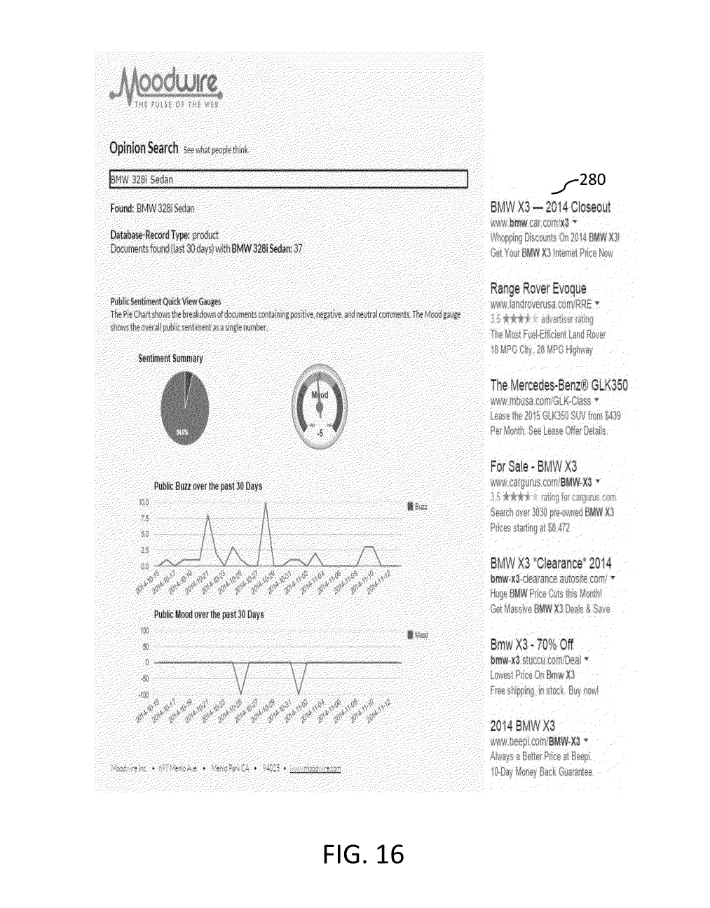

FIG. 16 is a graphical diagram illustrating an embodiment of the opinion search result displayed with both the sentiment summary and the computed advertisements related to the search query. In addition to the sentiment summary with pie charts and line graphs of public buzz and public mood, relevant, associated, and related information 280 to the search query of “BMW 328i sedan” are displayed on the right side of the opinion search result page, with advertisements other car models are in the similar class or compete with BMW 328i sedan market or BMW car dealerships that may be offering special promotion on certain vehicles for consumers who are interested in a BMW 328i sedan.

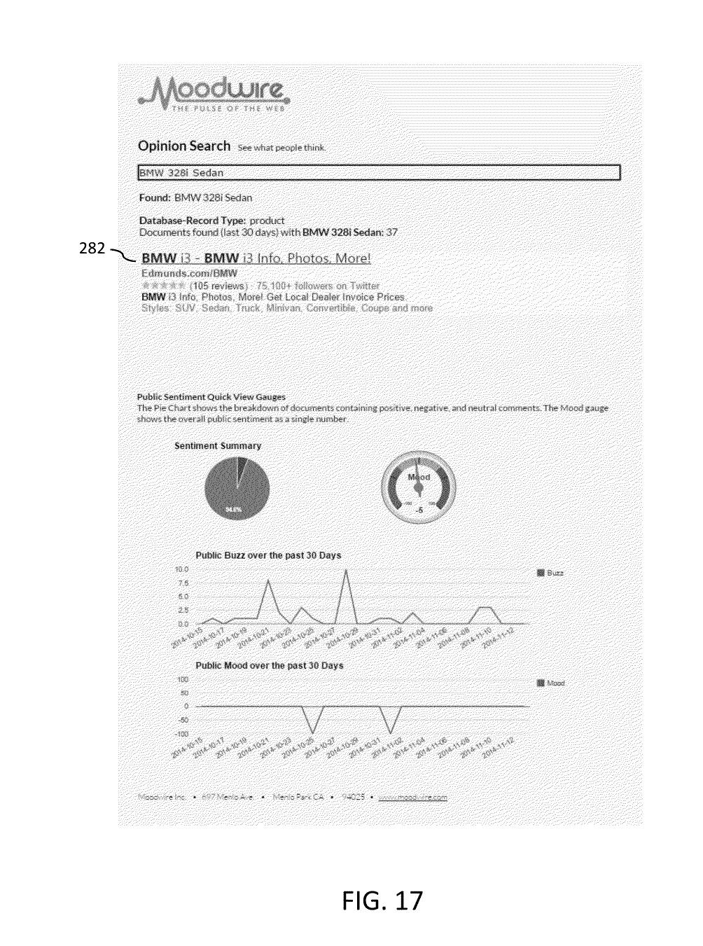

FIG. 17 is a graphical diagram illustrating an embodiment of the opinion search engine result with the sentiment summary and a related advertisement. After the user enters “BMW 328i Sedan” in the query box, the opinion search engine 20 processes and returns a sentiment summary, and a related vehicle advertisement 282 with social medial ratings of an auto dealer which sells similar vehicle, BMWi3, relative to the BMW 328i Sedan.

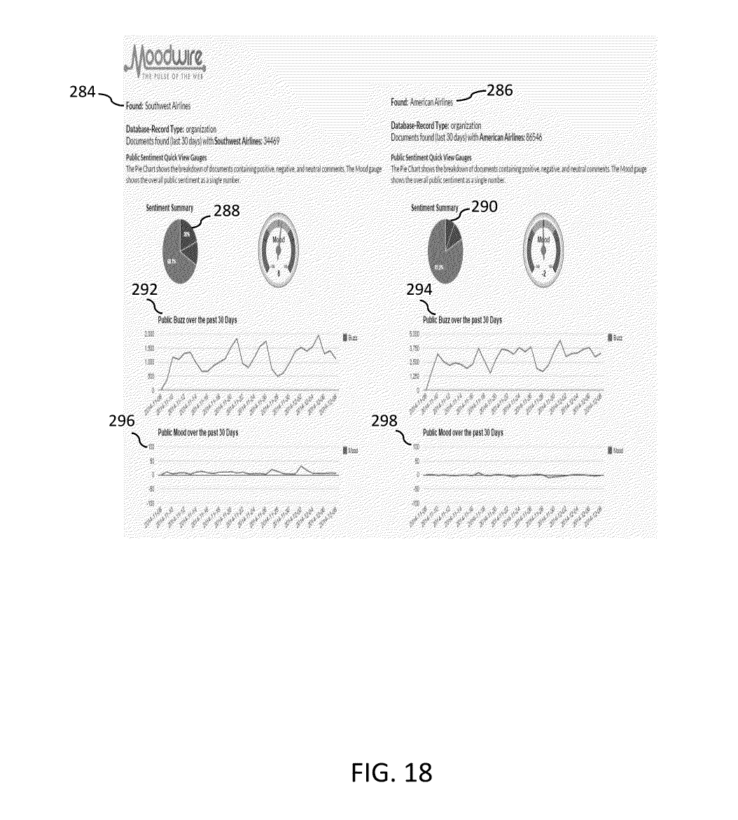

FIG. 18 is a graphical diagram illustrating one embodiment of the opinion search result which provide sentiment summaries, public buzzes and public moods for two entities. In the query box 252, a user may enter a query term which compares Southwest Airlines 284 with American Airlines 286. The opinion search engine 20 is configured to compute, process, and display the results with sentiment summaries, public buzzes, and public moods for both entities side by side, which may reveal the public opinions about the two airlines. In this example, Southwest Airlines has a higher percentage of positive sentiment 288 over the positive sentiment 290 of American Airlines. The public buzz chart 292 for Southwest Airlines and the public buzz chart 294 for American Airlines appear to be somewhat similar, although American Airlines has a greater amount of public comments over the same time period. Southwest Airlines, however, has a higher public mood chart 296 relative to a public mood chart 298 for American Airlines.

FIGS. 19A-O are graphical diagrams illustrating the different examples of opinion search results from the opinion search engine 20 with the visual transformed structural representation. In one embodiment, the visual transformed structural representation comprises a tree map. FIG. 19A is a sample search result 300 for “air transportation”. The result visual transformed page 300 displays the record type and the number of air transportation related documents found within the last 30 days on the production data storage aggregate 34. The result visual transformed page 300 displays some general information about the air transportation industry, with a geometric region 302 that comprises top ranked companies based on the amount of social media electronic messages. The size of each sub-geometric region for a particular company reflect the percentage of textual data relative to the entire body of the textual data for the ranked companies in air transported industry shown in the geometric region 302. The color of the block displayed reflects the majority sentiment, such as positive (coded as green) sentiment or negative (coded as red) sentiment, toward the entity name within the block. In this example, JetBlue Airways has a block color in green to reflect the generally public positive sentiment, while United Airlines has block color in red to reflect the generally public negative sentiment. The structural visual mapping representation can also displays the different entities by the size of the block. In this embodiment of the displayed result, the blocks are organized by size from top to bottom and then left to right such that the top left corner of the visual mapping representation structure is the entity with the most number of related documents for the topic. The other diagrams in FIGS. 19B-O illustrate similar types of process and display result for different query, entities, or industry. FIG. 19B is a sample search result for motor vehicles industry over the last 30 days with substantial public sentiments about BMW, Mercedes, Toyota and others; FIG. 19C is a sample search result for regional banks industry over the last 30 days with HSBC dominating the public sentiments from social medial sites; FIG. 19D is a sample search result for US state capitals over the last 30 days with substantial public sentiments about Phoenix, Denver and others; FIG. 19E is a sample search result for S&P 500 Index over the last 30 days with substantial public sentiments about eBay Inc., Starbucks Corp., Facebook Inc. Starwood Hotel & Resorts, Wal0Mark Stores Inc., and others; FIG. 19F is a sample search result for NBA teams over the last 30 days with fairly distributed public sentiments over many NBA teams; FIG. 19G is a sample search result for NFL teams over the last 30 days with substantial public sentiments about New England Patriots, Seattle Seahawks, Dallas Cowboys, Pittsburgh Steelers, Baltimore Ravens, and others; FIG. 19H is a sample search result for NHL teams dominated by Washington Capitals over the last 30 days; FIG. 19I is a sample search result for MLB teams dominated by San Francisco Giants over the last 30 days; FIG. 19J is a sample search result for actors over the last 30 days with substantial public sentiments about Justine Bieber, Ariana Grande, and others; FIG. 19K is a sample search result for celebs or celebrities over the last 30 days with substantial public sentiments about Harry Styles, Justin Bieber, Niall Horan and others; FIG. 19L is a sample search result for singers over the last 30 days with substantial public sentiments about Harry Styles, Justin Bieber and others; FIG. 19M is a sample search result for US senate over the last 30 days with a substantial amount of public sentiments about several senators, including Rand Paul, John McCain, Mitch McConnell, Bernard Sanders, and others; FIG. 19N is a sample search result for professional bull riders over the last 30 days dominated by the trio of Professional Bull Riders Inc., Ryan Miller, and Carlos Garcia; and FIG. 19O is a sample search result for hotels and motels over the last 30 days with substantial public sentiments about Marriott International Inc., Marriott Hotels & Resorts, Hilton Hotels Corp. and others.

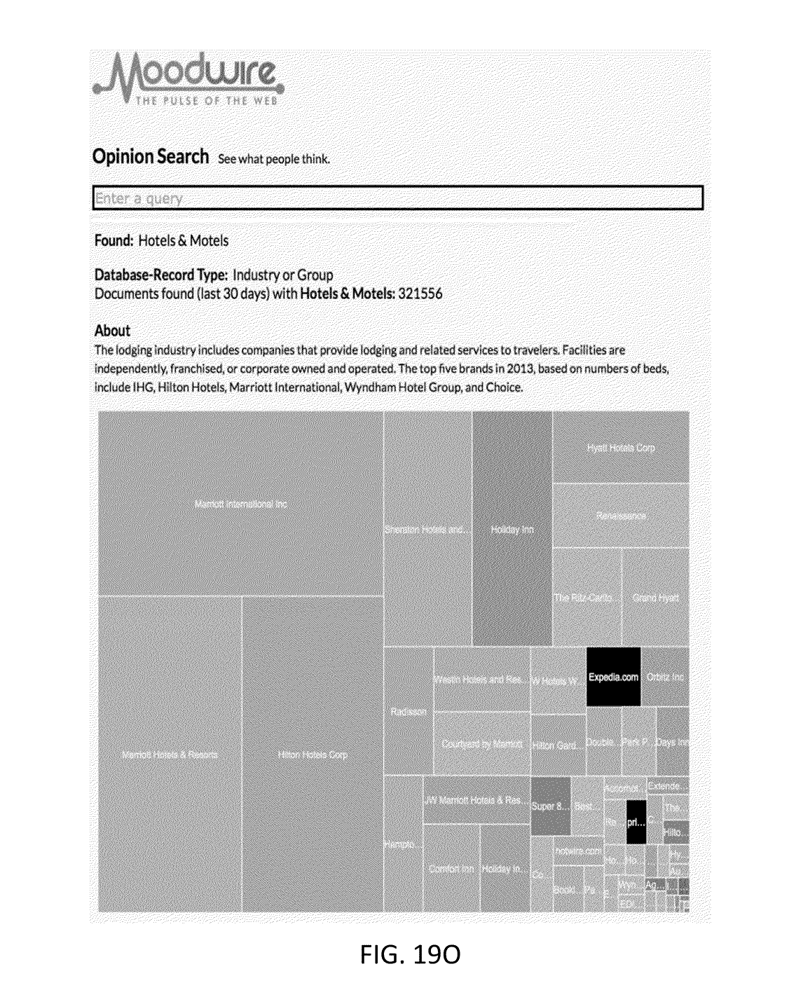

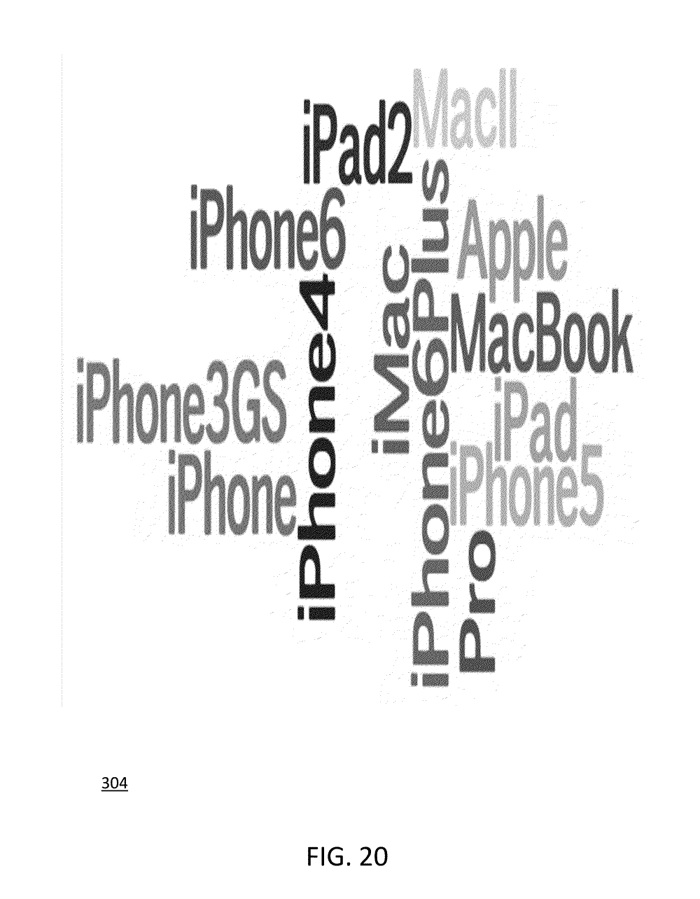

FIG. 20 is a graphical diagram illustrating an embodiment of the word cloud 304 generated from an opinion search result which shows another visual transformed structural representation by company products. In this example, the design of the word cloud 304 comprising of a host of Apple products, which is presented as a combination of horizontal, vertical and color coding of iPad, iPad2, iPhone, iPhone 3GS, iPhone4, iPhone5, iPhone6, iPhone6Plus, Apple MacBook, Math. The color coding scheme reflect the degree of positive sentiments, the degree of negative sentiments, or neutral sentiments about the various Apple products. As an added feature, the user is able to click on different parts of the word cloud 304 to show the opinion search result for that particular word or Apple product.

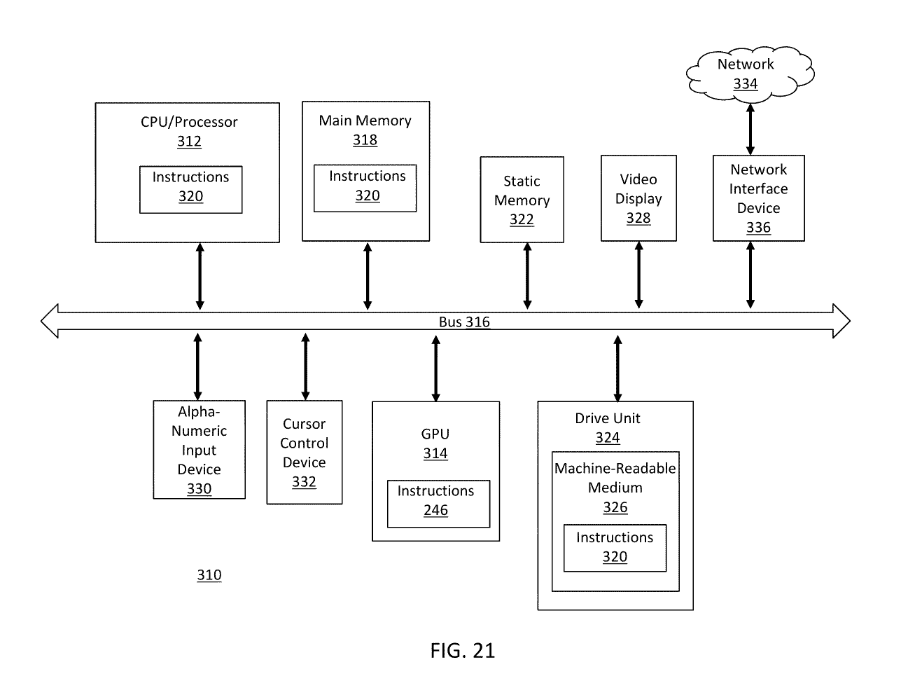

FIG. 21 is a block diagram illustrating an exemplary computer system for processing the push notifications upon which a computing embodiment of the present disclosure may be implemented. A computer system 310 includes a processor 312 (e.g., a central processing unit (CPU), a graphics processing unit (GPU), or both) are coupled to a bus 316 or other communication medium for sending and receiving information. The processors 312, 314 may be an example for implementing a computer on the mobile device, or other equivalent processors that are used to perform various functions described herein. In some cases, the computer system 310 may be used to implement the CPU 312 and the GPU 314 as a system-on-a-chip integrated circuit. The computer system 310 also includes a main memory 318, such as a random access memory (RAM) or other dynamic storage device, coupled to the bus 316 for storing information and instructions 320 to be executed by the CPU 312 and the GPU 314. The main memory 318 also may be used for storing temporary variables or other intermediate information during execution of instructions 2320 by the CPU 312 and the GPU 314. The computer system 310 further includes a read only memory (ROM) 322 or other static storage device coupled to the bus 316 for storing static information and instructions 320 for the CPU 312 and the GPU 314. A data storage device 324 with a computer-readable medium 326, such as a magnetic disk (e.g., a hard disk drive), an optical disk, or a flash memory, is provided and coupled to the bus 316 for storing information and instructions 320. The computer system 310 (e.g., desktops, laptops, tablets) may operate on any operating system platform using Windows® by Microsoft Corporation, MacOS or iOS by Apple, Inc., Linux, UNIX, and/or Android by Google Inc.

The computer system 310 may be coupled via the bus 316 to a display 328, such as a flat panel for displaying information to a user. An input device 330, including alphanumeric, pen or finger touchscreen input, other keys, or voice activated software application (also referred to as intelligent personal assistant or a software application that uses a natural language user interface) is coupled to the bus 316 for communicating information and command selections to the processor 312. Another type of user input device is cursor control 332, such as a mouse (either wired or wireless), a trackball, a laser remote mouse control, or cursor direction keys for communicating direction information and command selections to the CPU 312 and the GPU 314 and for controlling cursor movement on the display 274. This input device typically has two degrees of freedom in two axes, a first axis (e.g., x) and a second axis (e.g., y), that allows the device to specify positions in a plane.

The computer system 310 may be used for performing various functions (e.g., calculation) in accordance with the embodiments described herein. According to one embodiment, such use is provided by the computer system 310 in response to the CPU 312 and the GPU 314 executing one or more sequences of one or more instructions contained in the main memory 318. Such instructions may be read into the main memory 318 from another computer-readable medium 326, such as storage device 324. Execution of the sequences of instructions contained in the main memory 318 causes the CPU 312 and the GPU 314 to perform the processing steps described herein. One or more processors in a multi-processing arrangement may also be employed to execute the sequences of instructions contained in the main memory 318. In alternative embodiments, hard-wired circuitry may be used in place of or in combination with software instructions to implement the present disclosure. Thus, embodiments of the present disclosure are not limited to any specific combination of hardware circuitry and software.

The term “computer-readable medium” as used herein refers to any medium that participates in providing instructions to the CPU 312 and the GPU 314 for execution. Common forms of computer-readable media include, but are not limited to, non-volatile media, volatile media, transmission media, a floppy disk, a flexible disk, a hard disk, magnetic tape, any other magnetic medium, a CD-ROM, a DVD, a Blu-ray Disc, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read. Non-volatile media includes, for example, optical or magnetic disks, such as the storage device 324. Volatile media includes dynamic memory, such as the main memory 318. Transmission media includes coaxial cables, copper wire, and fiber optics. Transmission media can also take the form of acoustic or light waves, such as those generated during radio wave and infrared data communications.

Various forms of computer-readable media may be involved in carrying one or more sequences of one or more instructions to the CPU 312 and the GPU 314 for execution. For example, the instructions may initially be carried on a magnetic disk of a remote computer. The remote computer can load the instructions into its dynamic memory and send the instructions over a network 334 through a network interface device 336. The bus 316 carries the data to the main memory 318, from which the CPU 312 and the GPU 314 retrieve and execute the instructions. The instructions received by the main memory 318 may optionally be stored on the storage device 324 either before or after execution by the CPU 312 and the GPU 314.

The network (or communication) interface 336, which is coupled to the bus 316, provides a two-way data communication coupling to the network 334. For example, the communication interface 336 may be implemented in a variety of ways, such as an integrated services digital network (ISDN), a local area network (LAN) card to provide a data communication connection to a compatible LAN, a Wireless Local Area Network (WLAN) and Wide Area Network (WAN), Bluetooth, and a cellular data network (e.g. 3G, 4G). In wireless links, the communication interface 336 sends and receives electrical, electromagnetic or optical signals that carry data streams representing various types of information.

The computer system 310 is a computing machine which is capable of executing a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The memory 324 includes a machine-readable medium on which is stored one or more sets of data structures and instructions 320 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 320 may also reside, completely or at least partially, within memory 324 and/or within the processor 312 during execution thereof by computer system 310, with memory 318 and processor 312 also constituting machine-readable, tangible media.

The data structures and instructions 320 may further be transmitted or received over a network 334 via network interface device 336 utilizing any one of a number of well-known transfer protocols HyperText Transfer Protocol (HTTP)). Network 334 can generally include any type of wired or wireless communication channel capable of coupling together computing nodes (e.g., the computer system 310). This includes, but is not limited to, a local area network, a wide area network, or a combination of networks. In some embodiments, network 334 includes the Internet.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 310) or one or more hardware modules of a computer system (e.g., a processor 312 or a group of processors) may be configured by software an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 312 or other programmable processor) that is temporarily configured by software to perform certain operations. It will be appreciated that the decision to implement a hardware module mechanically, in dedicated and permanently, configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 312 configured using software, the general-purpose processor 312 may be configured as respective different hardware modules at different times. Software may accordingly configure a processor 312, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 312 that are temporarily configured (e.g., by software, code, and/or instructions stored in a machine-readable medium) or permanently configured to perform the relevant operations. Whether temporarily or permanently configured, such processors 312 may constitute processor-implemented (or computer-implemented) modules that operate to perform one or more operations or functions. The modules referred to herein may, in some example embodiments, comprise processor-implemented (or computer-implemented) modules.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one or more than one. The term “plurality,” as used herein, is defined as two or more than two. The term “another,” as used herein, is defined as at least a second or more.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed and desired to be secured by Letters Patent of the United States is:

1. A computer-implemented method for conducting an opinion search, comprising:
extracting by a computer entity information and attributes from each structured electronic social media message in the plurality of structured electronic social media messages and extracting entity information and attributes from each normalized unstructured electronic social media message in the plurality of unstructured electronic social media messages;
scoring by a computer a composite sentiment value and attributes for the text in each structured electronic social media message or each normalized unstructured electronic social media message,
storing by a computer the scored structured electronic social media messages and the scored normalized unstructured electronic social media message in a database; and
aggregating by a computer the results of the scored structured electronic social media messages and the scored normalized unstructured electronic social media messages for one or more entities organized for display as a transformed visual representation.

2. The method of claim 1, after the aggregating step, further comprising generating the transformed visual representation onto a user's computer display in response to the search query entered by the user.

3. The method of claim 2, after the aggregating step, further comprising computing an application programming interface (API) output suitable for sending the transformed visual representation to the user's computer display.

4. The method of claim 1, wherein the aggregating step comprising computing the scored structured electronic social media messages and the scored normalized unstructured electronic social media messages for a particular industry, the transformed visual representation organized by entities with the highest number of total structured and unstructured electronic social media messages and the corresponding opinion bias for the group of structured and unstructured electronic social media messages for a particular entity that is color coded.

5. The method of claim 1, wherein the aggregating step comprising computing the scored structured electronic social media messages and the scored normalized unstructured electronic social media messages for a particular industry, the transformed visual representation organized by entities and attributes with the highest number of total structured and unstructured electronic social media messages and the corresponding opinion bias for the group of structured and unstructured electronic social media messages for a particular entity that is color coded, the transformed visual representation including a public buzz curve over a specified period of time with the opinion amplitudes and quantities.

6. The method of claim 1, wherein the aggregating step comprising computing the scored structured electronic social media messages and the scored normalized unstructured electronic social media messages for a particular industry, the transformed visual representation organized by entities and attributes with the highest number of total structured and unstructured electronic social media messages and the corresponding opinion bias for the group of structured and unstructured electronic social media messages for a particular entity that is color coded, the transformed visual representation including a public buzz curve over a specified period of time with the opinion amplitudes and quantities, and the transformed visual representation including a public mood curve over a specified period of time with the mood amplitudes and quantities.

7. The method of claim 3, wherein the computer display displays the transformed visual representation as a geometric shape that encompasses a plurality of sub-geometric shapes, each sub-geometric shape having a geometric size that corresponds to the proportional percentage of social media electronic messages relative to the total amount for the entire geometric shape, each sub-geometric shape having a color that reflect the opinion bias for that population of the social media electronic messages.

8. The method of claim 3, wherein the computer display displaying the transformed visual representation as a tree map.

9. The method of claim 3, wherein the computer display displays the transformed visual representation as a word cloud, the word cloud having a plurality of products associated with a particular entity.

10. The method of claim 1, prior to the extracting step, further comprising receiving a large amount of social media electronic messages from one or more sources through one or more electronic communication mediums, the large amount of social media electronic messages including a plurality of unstructured electronic social media messages and a plurality of structured electronic social media messages textual data.

11. The method of claim 1, wherein the plurality of structured electronic social media message comprise a standard data format, and the plurality of normalized unstructured electronic social media messages comprise the same standard data format.

12. The method of claim 1, prior to the extracting step, further comprising detecting one or more entities from the plurality of unstructured electronic social media messages; and normalizing the plurality of unstructured electronic social media messages having a random format to the plurality of normalized unstructured electronic social media messages having a standard format.

13. The method of claim 12, wherein the detecting step comprises receiving and detecting text, tweets, news, reviews, and other sources from various social media websites that are determined to be raw and unstructured data.

14. The method of claim 13, wherein the raw data comprises unidentified entities and opinions toward the unidentified entities.

15. The method of claim 1, wherein the one or more entities having one or more entity relationships that are established by direct opinions as extracted from one or more entities embodied in one or more structured or unstructured electronic social media messages.

16. The method of claim 1, wherein the one or more entities having one or more entity relationships that are established by aggregated opinions as extracted from one or more entities embodied in one or more structured or unstructured electronic social media messages.

17. A computer-implemented method for conducting an opinion search, comprising:
receiving a query from a user;
extracting one or more entities from the query;
matching the one or more entities with the populated entities in a database, the database including a list of entities, each entity associating with one or more attributes which provides a contextual meaning to the entity; and
returning a resulting public opinion for the entity as derived and synthesized from unstructured public textual data sources over the Internet into a computer display.

18. The method of claim 17, wherein the one or more attributes infers an ontological relationship.

19. The method of claim 18, wherein the database including a list of core entities.

20. The method of claim 17, wherein the opinion search engine comprises the list of entities with taxonomy relationship, ontology relationship, and time series data.

21. The method of claim 17, wherein the opinion search engine returns the list of entities with taxonomy relationship, ontology relationship, and time series data that contain a buzz measurement, the number of times that the entity was mentioned in a predefined period.

22. The method of claim 17, wherein the opinion search engine returns the list of entities with taxonomy relationship, ontology relationship, and time series data that contain a mood measurement, the mood measurement including one or more positive sentiments and/or one or more negative sentiments that are defined over a time period.

23. The method of claim 22, further comprising displaying the resulting public opinion in a visual graph representation.

24. The method claim 22, wherein the visual graph representation comprises a line graph of time series data that denotes the buzz measurement over a predefined period.

25. The method claim 22, wherein the visual graph representation comprises positive and negative sentiments, and a sentiment magnitude for each entity.

26. The method of claim 17, wherein the returning step comprises retuning the resulting public opinion for the entity depending on the entity type.

27. The method of claim 17, wherein one or more entities comprise two entities for comparison between the two entities.

28. The method of claim 3, wherein the transformed visual graph representation comprises comparable results with a first visual representation for a first entity and a second visual representation for a second entity.
